(19) United States
(12) Patent Application Publication
(10) Pub. No.: US 2019/0360271 A1
(43) Pub. Date: Nov. 28, 2019

(54) CABLE TRAP SYSTEM AND METHOD

(71) Applicant: LOUISVILLE LADDER INC., Louisville, KY (US)

(72) Inventors: Victor Hugo Valdez Ontiveros, Nuevo Leon C.P. (MX); Andres Eduardo Reyes Acosta, Nuevo Leon C.P. (MX)

(21) Appl. No.: 16/439,556

(22) Filed: Jun. 12, 2019

Related U.S. Application Data
(63) Continuation-in-part of application No. 15/688,726, filed on Aug. 28, 2017.
(60) Provisional application No. 62/685,811, filed on Jun. 15, 2018.

(51) Int. Cl. E06C 1/36; E06C 1/06; E06C 7/48

(52) U.S. Cl. CPC E06C 1/36; E06C 7/48; E06C 1/06

(57) ABSTRACT

A safety apparatus for coupling with a ladder and methods for manufacturing and using same. The safety apparatus includes a first engagement member for coupling with a first rail of a ladder and defining a first engagement member recess and a second engagement member for coupling with a second rail of the ladder and defining a second engagement member recess. A third engagement member can couple with the first and second rails and be rotatable between a first position for engaging a first support structure and a second position for at least partially enclosing a second support structure within the first and second engagement member recesses. The safety apparatus advantageously can alternatively engage horizontal support structures or vertical support structures to prevent falls.

### CROSS-REFERENCE TO RELATED APPLICATIONS

This application is a continuation-in-part of copending U.S. patent application Ser. No. 15/688,726, filed on Aug. 28, 2017, and also claims the benefit of, and priority to, U.S. Provisional Patent Application Ser. No. 62/685,811, filed Jun. 15, 2018, each of which applications are incorporated herein by reference in their entireties and for all purposes.

### FIELD

The disclosed embodiments relate generally to safety systems and more particularly, but not exclusively, to fall prevention systems suitable for installation on ladders and other elevated platforms.

### BACKGROUND

Falls are a leading cause of injuries and effect millions of people every year. Many of these falls involve use of a ladder. Despite being considered basic tools, ladders are inherently dangerous. Some people may discount the dangerous nature of the ladders and thus can fall and suffer serious injuries, or even death. To help prevent falls, some extension ladders include cable hooks or other safety systems for stabilizing the ladders. Cable hooks, for example, can couple the ladder with a telephone cable, power line or the like, that is stretched in space. A cable hook, however, can unexpectedly detach from the cable during use of the ladder and result in a fall. To prevent such detachments, some conventional cable hooks include an adjacent latch for retaining the cable within the cable hook but require a rope to extend the length of the ladder for remotely opening the latch to manually release the cable after use of the ladder.

In view of the foregoing, a need exists for an improved safety system and method for preventing falls from ladders and other elevated platforms that overcome the aforementioned obstacles and deficiencies of currently-available ladder safety systems.

### BRIEF DESCRIPTION OF THE DRAWINGS

FIG. 1 is an exemplary top-level block diagram illustrating a ladder having a first safety apparatus disposed thereon.

FIG. 2 is an exemplary top-level block diagram illustrating an embodiment of the first safety apparatus of FIG. 1, wherein the first safety apparatus is in an open position.

FIG. 3 is an exemplary top-level block diagram illustrating an alternative embodiment of the first safety apparatus of FIG. 2, wherein the first safety apparatus is in an intermediate position during transition between the open position and a closed position.

FIG. 4 is an exemplary top-level block diagram illustrating another alternative embodiment of the first safety apparatus of FIG. 2, wherein the first safety apparatus is in a closed position.

FIG. 5 is an exemplary block diagram illustrating another still alternative embodiment of the first safety apparatus of FIG. 2, wherein an engagement member of the first safety apparatus includes a hook.

FIG. 6 is an exemplary block diagram illustrating still another alternative embodiment of the first safety apparatus of FIG. 2, wherein an engagement member of the first safety apparatus is at least partially lined with a non-skid surface material.

FIG. 7 is an exemplary block diagram illustrating still another alternative embodiment of the first safety apparatus of FIG. 2, wherein the first safety apparatus is coupled with the ladder via a mounting bracket including first and second bracket members.

FIG. 8 is an exemplary block diagram illustrating an alternative embodiment of the first safety apparatus of FIG. 7, wherein a weight is applied to the ladder.

FIG. 9 is an exemplary block diagram illustrating still another alternative embodiment of the first safety apparatus of FIG. 2, wherein a compressing member extends from an engagement member of the first safety apparatus.

FIG. 10 is an exemplary detail drawing illustrating an alternative embodiment of the first safety apparatus of FIG. 9, wherein the first safety apparatus is in an open position.

FIG. 11 is an exemplary detail drawing illustrating an alternative embodiment of the first safety apparatus of FIG. 10, wherein the first safety apparatus is viewed in a direction perpendicular to a plane parallel with rungs of the ladder.

FIG. 12 is an exemplary detail drawing illustrating another alternative embodiment of the first safety apparatus of FIG. 10, wherein the first safety apparatus is in an intermediate position during transition between the open position and a closed position.

FIG. 13 is an exemplary detail drawing illustrating still another alternative embodiment of the first safety apparatus of FIG. 10, wherein the first safety apparatus is in a closed position.

FIG. 14 is an exemplary block diagram illustrating still another alternative embodiment of the first safety apparatus of FIG. 2, wherein a retention member of the first safety apparatus is rotatably coupled with an engagement member of the first safety apparatus.

FIG. 15 is an exemplary detail drawing illustrating an alternative embodiment of the first safety apparatus of FIG. 14, wherein the first safety apparatus is in an open position.

FIG. 16 is an exemplary detail drawing illustrating an alternative embodiment of the first safety apparatus of FIG. 15, wherein the first safety apparatus is viewed in a direction perpendicular to a plane parallel with rungs of the ladder.

FIG. 17 is an exemplary detail drawing illustrating another alternative embodiment of the first safety apparatus of FIG. 15, wherein the first safety apparatus is in an intermediate position during transition between the open position and a closed position.

FIG. 18 is an exemplary detail drawing illustrating still another alternative embodiment of the first safety apparatus of FIG. 15, wherein the first safety apparatus is in a closed position.

FIG. 19 is an exemplary detail drawing illustrating still another alternative embodiment of the first safety apparatus of FIG. 15, wherein the first safety apparatus is in a lock position.

FIG. 20 is an exemplary detail drawing illustrating still another alternative embodiment of the first safety apparatus of FIG. 15, wherein the first safety apparatus is in a plan parallel with rungs of the ladder.

FIG. 21 is an exemplary detail drawing illustrating an alternative embodiment of the first safety apparatus of FIG. 20, wherein the first safety apparatus is viewed in a direction perpendicular to a plane parallel with rungs of the ladder.

FIG. 22A is an exemplary detail drawing illustrating still another alternative embodiment of the safety apparatus of FIG. 1, wherein the safety apparatus is adapted to engage a vertical support structure.

FIG. 22B is an exemplary detail drawing illustrating an alternative embodiment of the safety apparatus of FIG. 22A, wherein the safety apparatus forms a support recess for receiving the vertical support structure.

FIG. 23 is an exemplary detail drawing illustrating an alternative embodiment of the safety apparatus of FIG. 22B, wherein a retention member of the safety apparatus is in an intermediate position during transition between an open position and a closed position.

FIG. 24 is an exemplary detail drawing illustrating an alternative embodiment of the safety apparatus of FIG. 23, wherein the retention member is in the closed position.

FIG. 25A is an exemplary detail drawing illustrating an embodiment a mounting bracket for the safety apparatus of FIG. 22B, wherein the mounting bracket includes an extension member assembly for engaging the retention member.

FIG. 25B is an exemplary detail drawing illustrating an exploded view of the extension member assembly of FIG. 25A.

FIG. 26 is an exemplary detail drawing illustrating an embodiment of the extension member assembly of FIGS. 25A-B, wherein the extension member assembly is shown as engaging the retention member.

FIG. 27A-B are exemplary detail drawing illustrating another alternative embodiment of the safety apparatus of FIG. 22B, wherein an engagement member of the safety apparatus is ready for use.

FIG. 28A-B are exemplary detail drawing illustrating an alternative embodiment of the safety apparatus of FIGS. 27A-B, wherein the engagement member is in a retracted position.

FIG. 29A-B are exemplary detail drawing illustrating another alternative embodiment of the safety apparatus of FIGS. 28A-B, wherein the retracted engagement member is in a partially rotated position.

FIG. 30A-B are exemplary detail drawing illustrating another alternative embodiment of the safety apparatus of FIGS. 28A-B, wherein the retracted engagement member is in a fully rotated position.

FIG. 31A-B are exemplary detail drawing illustrating another alternative embodiment of the safety apparatus of FIGS. 27A-B, wherein the engagement member is in a stowed position.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

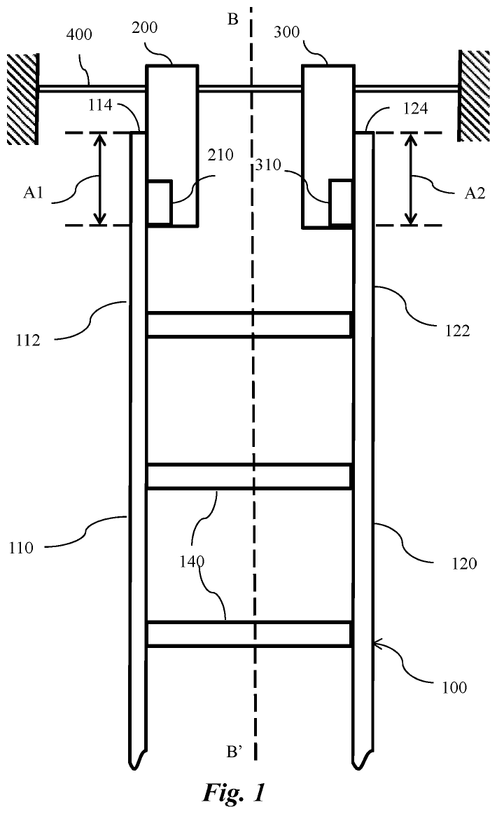

Since currently-available ladder safety systems can unexpectedly detach during use of the ladder and must be manually actuated after use of the ladder is completed, a safety system and method for preventing falls from ladders and other elevated platforms can prove desirable and provide a basis for a wide range of applications, such as extension ladders. This result can be achieved, according to one embodiment disclosed herein, by a ladder 100 as illustrated in FIG. 1.

The ladder 100 in FIG. 1 can comprise any type of conventional ladder. Exemplary types of ladders can include a step ladder, an extension ladder, a platform ladder, a step stool, a multipurpose ladder, a telescoping ladder, a folding ladder or any other conventional type of ladder without limitation. The ladder 100 of FIG. 1 includes first and second side rails 110, 120 separated by a predetermined distance. The first and second side rails 110, 120 have upper side rail portions 112, 122, respectively. When the ladder 100 is in use, the first and second side rails 110, 120 can be positioned relative to the ground at a selected angle (not shown) such that the upper side rail portions 112, 122 can be positioned distally to the ground. The upper side rail portion 112 includes an upper end region 114 where the first side rail 110 terminates. The upper side rail portion 112 includes an upper end region 124 where the second side rail 120 terminates.

The ladder 100 of FIG. 1 includes a plurality of rungs (also referred to as cross-members or cross pieces) 140 coupling the first and second side rails 110, 120. FIG. 1 shows the ladder 100 as including first and second safety apparatuses 200, 300. The first and second safety apparatuses 200, 300 preferably are disposed adjacent to the upper end regions 114 of the ladder 200.

The first safety apparatus 200 includes a first mounting bracket (also referred to as first ladder mounting bracket) 210 for coupling with the first upper side rail portion 112 of the first side rail 110 at a first predetermined distance A1 from the upper end region 114 of the first side rail 110. The second safety apparatus includes a second mounting bracket (also referred to as second ladder mounting bracket) 310 for coupling with the upper side rail portion 122 of the second side rail 120 at a second predetermined distance A2 from the upper end region 124 of the second side rail 120. As illustratively shown in FIG. 1, the second predetermined distance A2 can be equal to the first predetermined distance A1.

FIG. 1 shows the ladder 100 as being attached to a selected structure 400. The selected structure 400 can include any object that can be engaged with the first and/or second safety apparatuses 200, 300 such that the ladder 100 can be at least partially stabilized by the selected structure 400 during use. An exemplary selected structure 400 can include a gutter, a wire, cord or other type of cable, such as an overhead cable, a utility line, a cable or wire used for telephone, a cable or wire used for cable television, a power line, a safety cable or the like.

According to the first and second safety apparatuses 200, 300 in various embodiments in the present disclosure, the engagement of a selected structure 400 by the first and second safety apparatuses 200, 300 can increase as weight is added to the ladder 100. The engagement of the selected structure 400 by the first and second safety apparatuses 200, 300 can decrease as the weight is removed from the ladder 100.

In one example, the second safety apparatus 300 can be in mirror symmetry with the first safety apparatus 200. Stated somewhat differently, structures of the first and second apparatuses 200, 300 can be uniform. Advantageously, the ladder 100 can be symmetrically engaged with the selected structure 400 and stability of the ladder 100 during use can be improved. In another example, the second safety apparatus 300 is not in mirror symmetry with the first safety apparatus 200. Stated somewhat differently, structure of the second safety apparatus 300 can be different from structure of the first safety apparatus 200.

The ladder 100 of FIG. 1 can be configured to engage the selected structure 400 at the onset of use and can maintain the engagement with the selected structure 400 while the ladder 100 remains in use. In one embodiment, the ladder 100 can automatically engage the selected structure 400 when use of the ladder 100 is initiated and/or can automatically disengage the selected structure 400 when use of the ladder 100 is complete. The ladder 100 advantageously can inhibit unexpectedly detachment from the selected structure 400 during use and does not require manual disengagement of the selected structure 400 after use is completed.

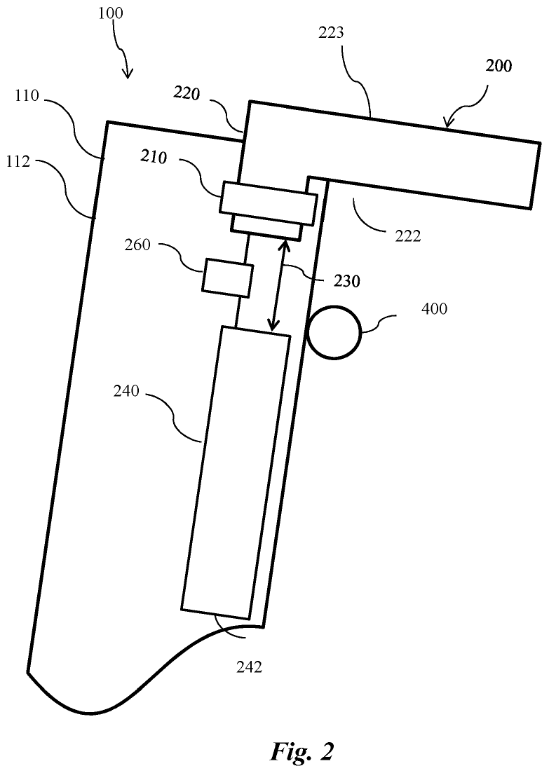

FIG. 2 shows the first safety apparatus 200 in a cross-sectional view of the ladder 100 in a plane indicated by line BB' (shown in FIG. 1) and perpendicular to the rungs 140 (shown in FIG. 1). FIG. 2 shows the first safety apparatus 200 as including the first mounting bracket 210 for coupling with the first side rail 110 of the ladder 100. The first safety apparatus 200 includes an engagement member 220 slidably engaging the first mounting bracket 210.

The engagement member 220 can include an engagement member portion 223 for defining an engagement member recess 222 for receiving the selected structure 400. Stated somewhat differently, the engagement member portion 223, in cooperation with the upper side rail portion 112 of the first side rail 110, can form the engagement member recess 222.

FIG. 2 shows the first safety apparatus 200 as including a retention member (also referred to as cable trap) 240. The retention member 240 can have an end region (also referred to as cable trap end region) 242 being rotatable relative to the engagement member 220 such that the retention member 240 can extend distally from the engagement member 220 in an open position. In the open position, the selected structure 400 can freely enter and exit from the engagement member recess 222.

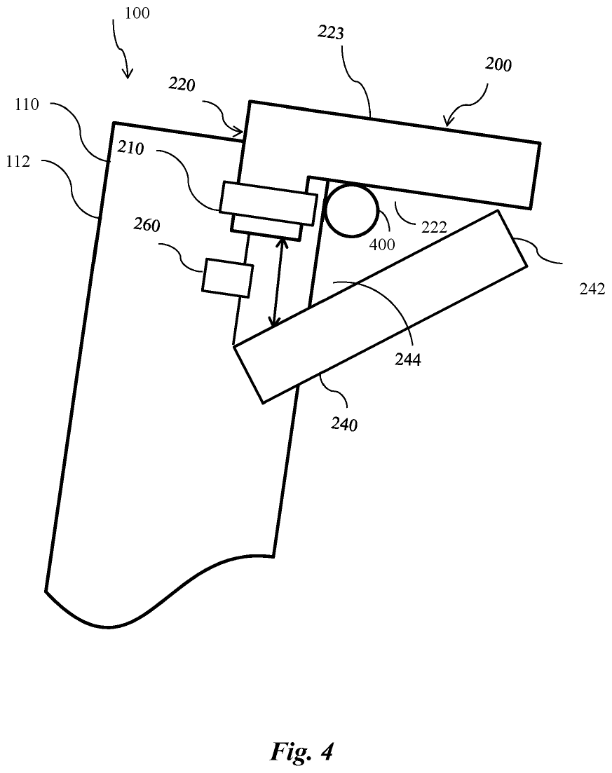

The end region 242 of the retention member 240 can be rotatable relative to the engagement member 220 such that the retention member 240 can extend proximally to the engagement member 220 in a closed position (shown in FIG. 4). In the closed position, the selected structure 400 can be trapped in the engagement member recess 222.

The retention member 240 can transition from the open position to the closed position for at least partially enclosing the selected structure 400 within the engagement member recess 222 when weight is applied to the ladder 100. The weight can be applied to the ladder 100 in any appropriate manner. For example, at the onset of use of the ladder 100, the ladder 100 can be loaded onto the selected structure 400 by grasping the selected structure 400 within the engagement member recess 222. Under gravity, weight of the ladder 100 can be at least partially loaded onto the selected structure 400. As a result, the selected structure 400 is in contact with the engagement member 220 and exerts a force to push upward against the engagement member 220 to support the weight of the ladder 100. Effectively, the weight is applied to the ladder 100. Additionally and/or alternatively, an operator can step onto one or more of the rungs 140 (shown in FIG. 1) of the ladder 100 to apply a weight of the operator to the ladder 100.

The retention member 240 can transition from the closed position to the open position for at least partially releasing the selected structure 400 when the weight is removed from the ladder 100. The weight can be removed from the ladder 100 in any appropriate manner. For example, at the end of use of the ladder 100, the ladder 100 can be lifted upward relative to the ground so the selected structure 400 is removed from contact with the engagement member 220. As a result, the selected structure 400 no longer exerts the force to push upward against the engagement member 220 and to support the weight of the ladder 100. Effectively, the weight is removed from the ladder 100. Additionally and/or alternatively, when the operator is on one or more of the rungs 140 during use of the ladder 100. The operator can step off from the rungs 140 to remove the weight of the operator from the ladder 100.

In one embodiment, the first and second safety apparatuses 200, 300 can each transition to capture the selected structure 400 as a weight of the operator is added to a selected rung 140. For example, the weight of the operator is added to the selected rung 140 when an operator steps on the selected rung 140 to load at least part of body weight of the operator onto the ladder 100. The first and second safety apparatuses 200, 300 each can transition to release the selected structure 400 as the weight of the operator is removed from the rung 140.

FIG. 2 shows the first safety apparatus 200 as including an optional biasing system 260 for biasing the engagement member 220 and the retention member 240 into the open position. The biasing system 260 can include any structure that can exert a force for keeping the engagement member 220 and the retention member 240 into the open position when no weight is applied to the ladder 100. An exemplary biasing system 260 can include an elastic object capable of storing mechanical energy. For example, the biasing system 260 can include at least one spring.

FIG. 2 shows the first safety apparatus 200 as including a cooperating member 230 for implementing the cooperation between the engagement member 220 and the retention member 240. The cooperating member 230 can include one or more components that are part of the engagement member 220 and/or the retention member 240. Additionally and/or alternatively, the cooperating mechanism 230 can include one or more components that are in addition to the engagement member 220 and the retention member 240.

The cooperating member 230 can function such that the retention member 240 can transition between the open position and the closed position based on the weight applied to the ladder 100. In one embodiment, the retention member 240 can extend distally from the engagement member 220 to be in the open position when the selected structure 400 does not exert the force that pushes upward against the engagement member 220. The retention member 240 can extend proximally to the engagement member 220 in the closed position when the selected structure 400 exerts the force to push against the engagement member 220.

Additionally and/or alternatively, the first safety apparatus 200 can include a locking system (not shown) for locking the retention member 240 in the closed position. A force can be applied to the first safety apparatus 200 to unlock the retention member 240 from the closed position. For example, the force can include a force that pressures the engagement member 220 toward ground. An exemplary locking system can include any appropriate structure located between the first mounting bracket 210 and the engagement member 220. For example, the locking system can include a locking device having a saw-toothed shape.

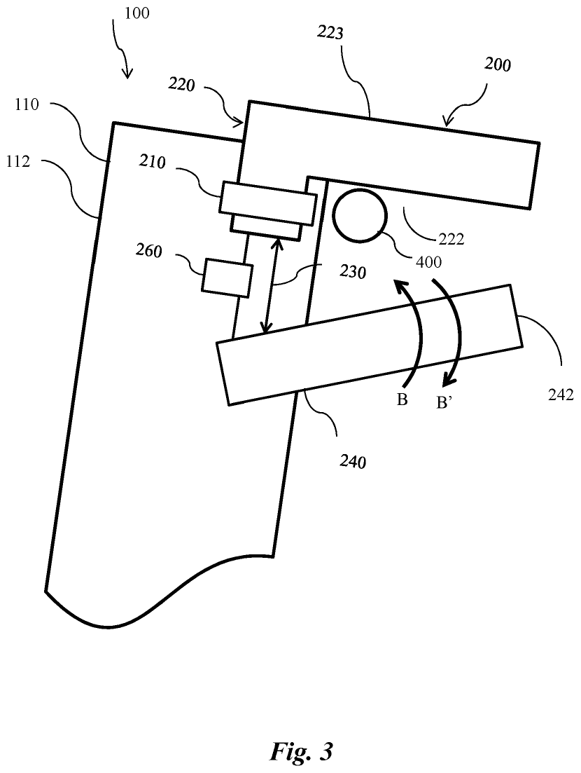

FIG. 3 shows the first safety apparatus 200 in an intermediate position during transition between the open position (shown in FIG. 2) and the closed position (shown in FIG. 4). An engagement of the selected structure 400 between the engagement member 220 and the retention member 240 in the closed position can progressively increase as additional weight is applied to the ladder 100. Stated somewhat differently, as additional weight is applied to the ladder 100, the retention member 240 can rotate in direction B to reduce opening between the engagement member 220 and the end region 242 of the retention member 240. Thus, likelihood of disengagement of the selected structure 400 from the engagement member recess 222 is reduced.

The engagement of the selected structure 400 by the engagement member 220 and the retention member 240 can progressively decrease as the additional weight is removed from the ladder 100. Stated somewhat differently, as the additional weight is removed from the ladder 100, the retention member 240 can rotate in direction B′ to reduce the opening between the engagement member 220 and the end region 242 of the retention member 240. Thus, likelihood of disengagement of the selected structure 400 from the engagement member recess 222 is increased.

FIG. 4 shows the first safety apparatus 200 in the closed position. When the weight is applied to the ladder 100, the retention member 240 can be in the closed position and enclose the selected structure 400 within the engagement member recess 222. The selected structure 400 can thus be trapped within the engagement member recess 222 without a possibility of escaping. Advantageously, detachment of the ladder 100 from the selected structure 400 can be prevented, falling of the ladder 100 to the ground can be avoided, and security of using the ladder 100 can be improved.

As shown in FIG. 4, the retention member 240 defines a retention member recess (also referred to as trap body recess) 244 that cooperates with the engagement member recess 222 such that the selected structure 400 is enclosed within the retention member recess 244 and the engagement member recess 222 when the retention member 240 is in the closed position. Stated somewhat differently, the retention member 240 in the closed position, in cooperation with the upper side rail portion 112 of the first side rail 110, can form the retention member recess 244. The retention member recess 244 and the engagement member recess 222 can form space for trapping the selected structure 400.

Although FIG. 4 shows the retention member 240 as completely enclosing the selected structure 400 within the engagement member recess 222, the retention member 240 in the closed position can partially enclose the selected structure 400 within the engagement member recess 222, without limitation. For example, the opening between the engagement member 220 and the end region 242 of the retention member 240 in the closed position can be smaller than a size of the selected structure 400. Thus, the selected structure 400 can still be trapped within the engagement member recess 222 without the possibility of escaping. Advantageously, security of using the ladder 100 can be improved. When the weight is removed from the ladder 100, the retention member 240 can transition to the open position (shown in FIG. 2) and release the selected structure 400.

Although the view the first safety apparatus 200 of in FIG. 4 shows the retention member 240 as completely enclosing the selected structure 400 within the engagement member recess 222 without an overlap with the engagement member 220, the retention member 240 and the engagement member 220 can be in any relative position for engaging the selected structure 400, without limitation. For example, the retention member 240 in the closed position can at least partially overlap with the engagement member 220 in a view that is the same as the view in FIG. 4

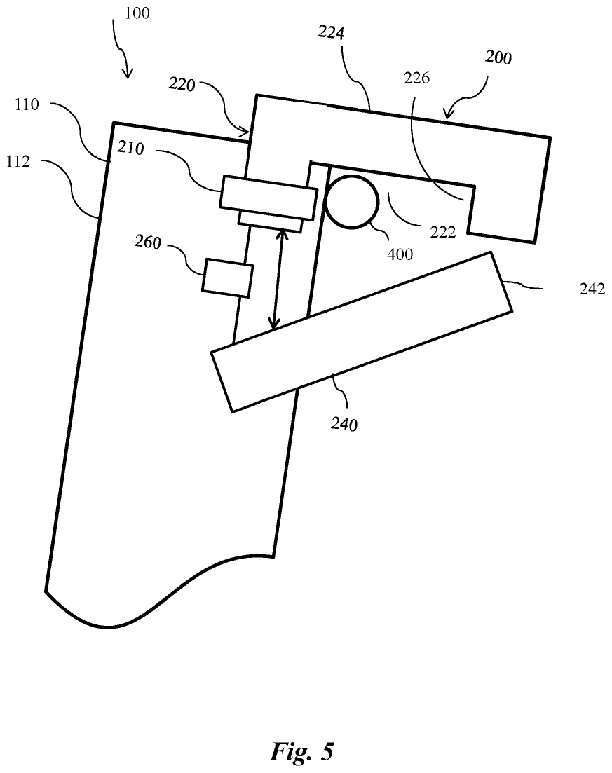

FIG. 5 shows the engagement member 220 as including a hook (also referred to as cable hook) 224 defining a hook mouth 226. As shown in FIG. 5, in the closed position, the retention member 240 can at least partially enclose the selected structure 400 within the hook mouth 226 when the weight is applied to the ladder 100.

The selected structure 400 can be secured within the hook mouth 226 at the onset of use of the ladder 100. Thus, during transition of the retention member 240 from the open position to the closed position, detachment of the selected structure 400 from the engagement member 220 can be prevented. Advantageously, success of trapping the selected structure 400 within the engagement member recess 222 can be ensured, and safety and convenience of using the ladder 100 can be improved.

Although FIG. 5 shows the hook mouth 226 as having a rectangular shape, the hook mouth 226 can include having any type of indented portion for accommodating the selected structure 400. For example, the hook mouth 226 can be curved, triangular, square, rectangular, or a combination thereof.

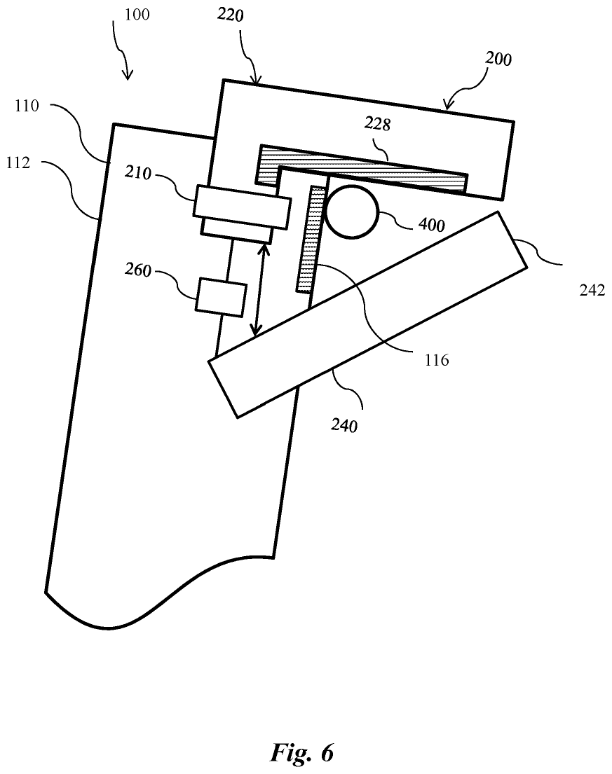

Turning to FIG. 6, the engagement member 220 is shown as being at least partially lined with a non-skid surface material 228 for securing an engagement between the engagement member 220 and the selected structure 400. Advantageously, relative slipping and/or sliding motion between the engagement member 220 and the selected structure 400 can be reduced or eliminated. Stability of the ladder 100 during use can advantageously be improved.

Additionally and/or alternatively, the upper side rail portion 112 of the first side rail 110 is shown as being at least partially lined with a non-skid surface material 116 for securing the engagement with the selected structure 400. Advantageously, relative slipping and/or sliding motion between the first side rail 110 and the selected structure 400 can be reduced or eliminated. Stability of the ladder 100 during use can advantageously be improved.

The non-skid surface materials 228, 116, also referred to as non-slip materials or anti-slip materials, can include any materials that has a high friction with the selected structure 400. In a non-limiting example, the non-skid surface materials 228, 116 can include neoprene, ethylene propylene diene monomer (M-class) rubber (EPDM rubber), polyvinyl chloride (PVC) foam, polyethylene, sponge rubber, silicone foam, urethane, cork, rubber, felt, acrylic, polyester, styrene-butadiene or styrene-butadiene rubber (SBR), or a combination thereof. The non-skid surface materials 228, 116 be uniform and/or different.

Optionally, the upper side rail portion 122 (shown in FIG. 1) of the second side rail 120 (shown in FIG. 1) can be at least partially lined with a non-skid surface material (not shown) for securing the engagement with the selected structure 400. The non-skid surface material on the upper side rail portion 122 can be uniform with and/or different from the non-skid surface materials 228, 116. In one embodiment, the non-skid surface material on the upper side rail portion 122 can be uniform with the non-skid surface material 228, so the upper side rail portions 112, 122 can equally resist skidding of the selected structure 400. Advantageously, the ladder 100 can be symmetrically secured with the selected structure 400 and stability of the ladder 100 during use can be improved.

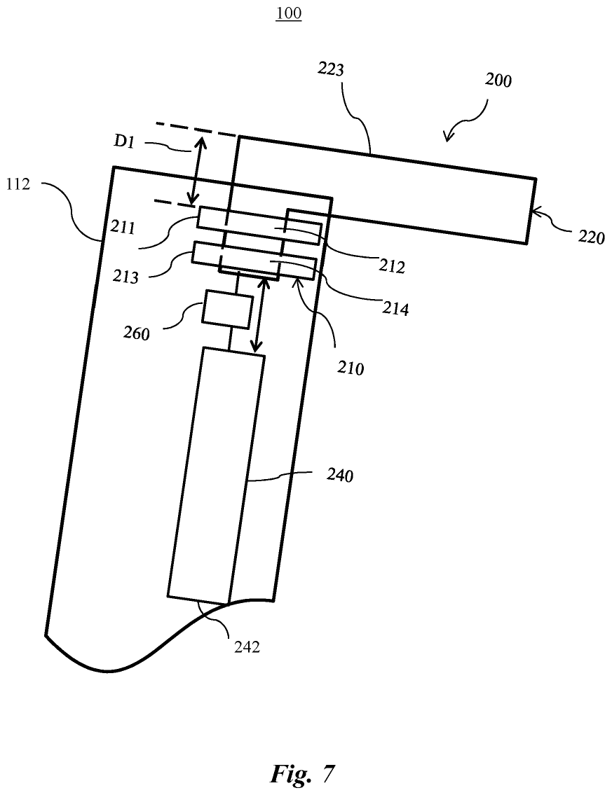

Turning to FIG. 7, the first mounting bracket 210 is shown as including a first bracket member 211 defining a first bracket opening 212 (indicated via dashed lines) and a second bracket member 213 defining a second bracket opening 214 (indicated via dashed lines). FIG. 7 shows the second bracket opening 214 as being axially aligned with the first bracket opening 212. The engagement member 220 is shown as being at least partially disposed within the first and second bracket openings 212, 214 and extends from the first and second bracket members 211, 212.

As shown in FIG. 7, when the retention member 240 is in the open position, the engagement member portion 223 extends from the first bracket member 211 by a first predetermined distance Dl. Stated somewhat differently, when no weight is applied to the ladder 100, the engagement member portion 223 extends from the first bracket member 211 by the first predetermined distance D1.

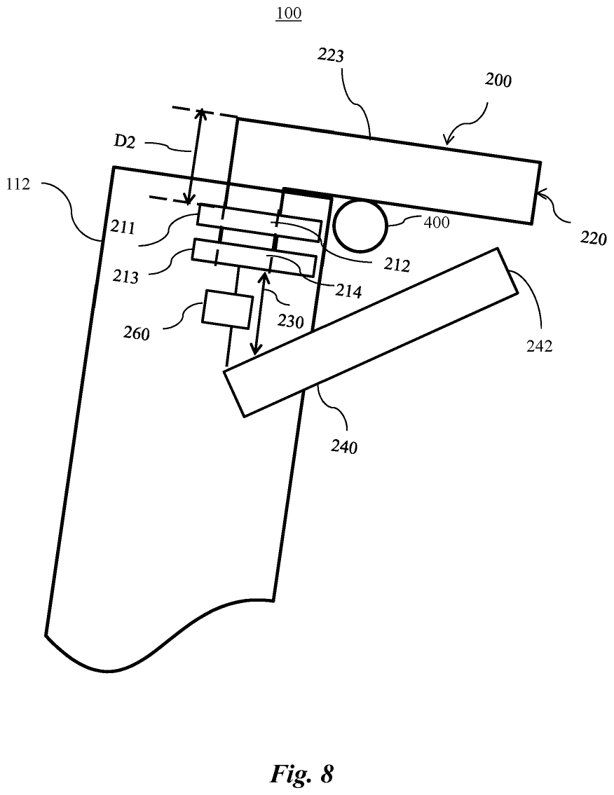

Turning to FIG. 8, the retention member 240 is shown as being in the closed position. For example, the weight can be applied to the ladder 100. In response to the weight being applied to the ladder 100, the engagement member 220 can slide within the first and second bracket openings 212, 214. As a result, the engagement member portion 223 is shown as extending from the first bracket member 211 by a second predetermined distance D2.

The second predetermined distance D2 is shown as being greater than the first predetermined distance D1 (shown in FIG. 7). Stated somewhat differently, the selected structure 400 can exert the force to push against the engagement member 220 and thus move the engagement member portion 223 relative to the first bracket member 211. The cooperating member 230 can function to rotate the retention member 240 from the open position to the closed position in response to shifting of the engagement member portion 223 distally from the first bracket member 211.

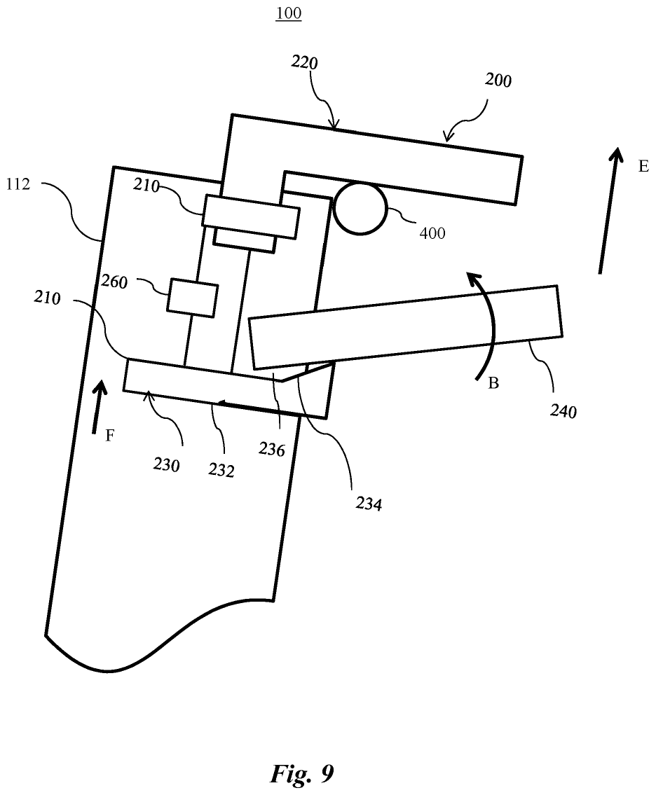

FIG. 9 shows the first safety apparatus 200 in an intermediate position during transition between the open position (shown in FIG. 2) and the closed position (shown in FIG. 4). The cooperating member 230 is shown as including a compressing member 232 extending from the engagement member 220.

The compressing member 232 can be coupled to the engagement member 220 for moving synchronously with the engagement member 220. For example, the compressing member 232 can be fixedly coupled to and/or supported by the engagement member 220. Thus, when the weight is applied to the ladder 100, the engagement member 220 can slide relative to the first mounting bracket 210 in a direction E. The direction E can indicate a first selected direction that at least partially points away from the ground when the ladder 100 is in use. The compressing member 232 can move in a direction F. The direction F can indicate a second selected direction that at least partially points away from the ground when the ladder 100 is in use. The direction E can be parallel to the direction F. Additionally and/or alternatively, a difference between the directions E, F can be smaller than 90 degrees so the compressing member 232 can move farther from the ground when the engagement member 220 moves farther from the ground.

Via movement in the direction F, the compressing member 232 can engage the retention member 240 to transition the retention member 240 into the closed position. Stated somewhat differently, the compressing member 232 can push the retention member 240 such that the retention member 240 can rotate in the direction B to transition into the closed position. FIG. 9 shows the compressing member 232 as including an angled end portion 234 at end of the compressing member 232 and extending proximally to the retention member 240. The angled end portion 234 defines a compressing member recess 236 facing the retention member 240. The angled end portion 234 can provide support to the retention member 240 such that the retention member 240 can rotate into the closed position during movement in the direction F. Optionally, in the closed position, a surface of the angled end portion 234 can be in contact with a surface of the retention member 240 proximal to the angled end portion 234.

Optionally, the biasing system 260 can include at least one spring (not shown) being disposed between the compressing member 232 and the mounting bracket 210. The spring can bias the compressing member 232 distally from the retention member 240. Stated somewhat differently, when the weight is not applied to the ladder 100, the spring can provide a force to keep the compressing member 232 from moving in the direction F and/or move relative to the mounting bracket 210. Thus, the spring can prevent the compressing member 232 from contacting the retention member 240 and/or pushing the retention member 240 into the closed position. In one example, the biasing system 260 can include a plurality of springs coupled in series and/or in parallel.

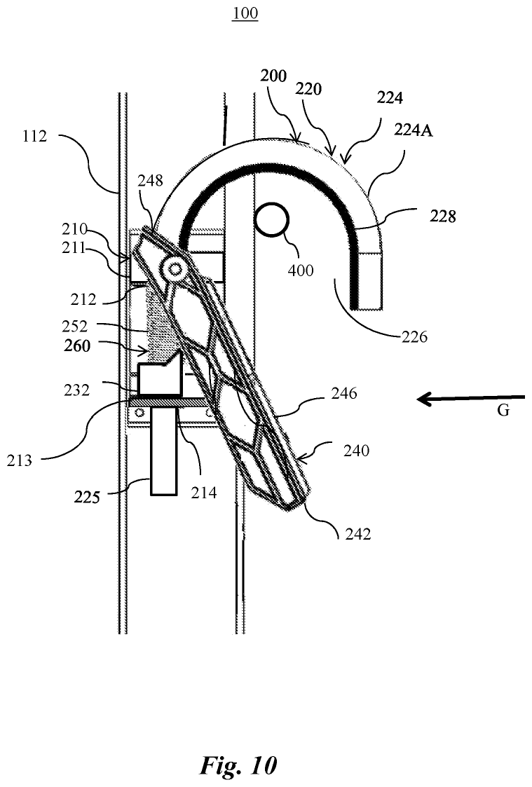

FIG. 10 shows a detail drawing of the ladder 100 with the first safety apparatus 200 in the open position. The first safety apparatus 200 is shown as including the first mounting bracket 210 with the first bracket member 211 defining the first bracket opening 212 and the second bracket member 213 defining the second bracket opening 214. The second bracket opening 214 is shown as being axially aligned with the first bracket opening 212.

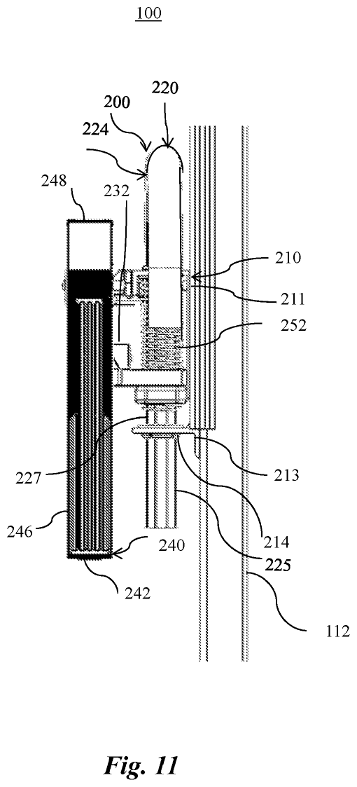

The first safety apparatus 200 is shown as including the engagement member 220 that includes the hook 224. The hook 224 can include a hook region 224A having an arcuate shape for defining the hook mouth 226. The engagement member 220 is shown as including a hook base region 225 having a hook base region periphery 227 (shown in FIG. 11) that can include an external circumference of the hook base region 225. The compressing member 232 can extend from the hook base region periphery. The hook base region 225 is shown as disposed within the first and second bracket openings 212, 214, such that the compressing member 232 can be slidable between the first and second bracket members 211, 213. The hook 224 is shown as extending from the first bracket member 211 and lined with the non-skid surface material 228.

The biasing system 260 shown in FIG. 10 includes at least one spring 252 being disposed about the hook base region periphery between the first bracket member 211 and the compressing member 232 and biasing the compressing member 232 adjacent to the second bracket member 213.

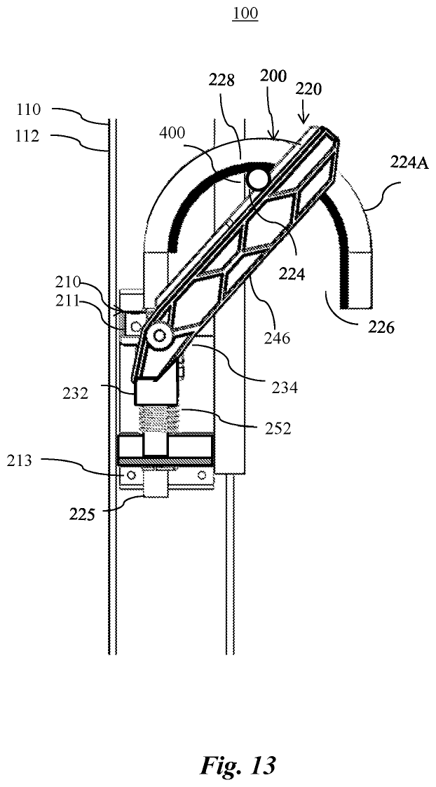

The first safety apparatus 200 is shown as including the retention member 240. The retention member 240 includes a cable trap body 246. The cable trap body 246 can have an elongated shape and have the end region 242 and an end region (also referred to as cable trap end region) 248 opposite to the end region 242. The end region 248 can be pivotally coupled with the first bracket member 211 such that the cable trap body 246 can extend adjacent to the second bracket member 213 in the open position. The cable trap body 246 can enclose the hook mouth 226 in the closed position (shown in FIG. 13).

FIG. 11 shows the first safety apparatus 200 of FIG. 10 that is viewed in a direction G (shown in FIG. 10). The direction G is perpendicular to a plane parallel with rungs 140 (shown in FIG. 1) of the ladder 100. A hook base region periphery 227 is shown as extending from the hook base region 225 and located distally from the upper side rail portion 112. The end region 248 can be pivotally coupled with the first bracket member 211 and located distally from the upper side rail portion 112.

The compressing member 232 is shown as extending from the hook base region periphery 227 and distally from the upper side rail portion 112 such that any movement of the compressing member 232 between the first and second bracket members 211, 213 is at least partially aligned with elongation direction of the cable trap body 246.

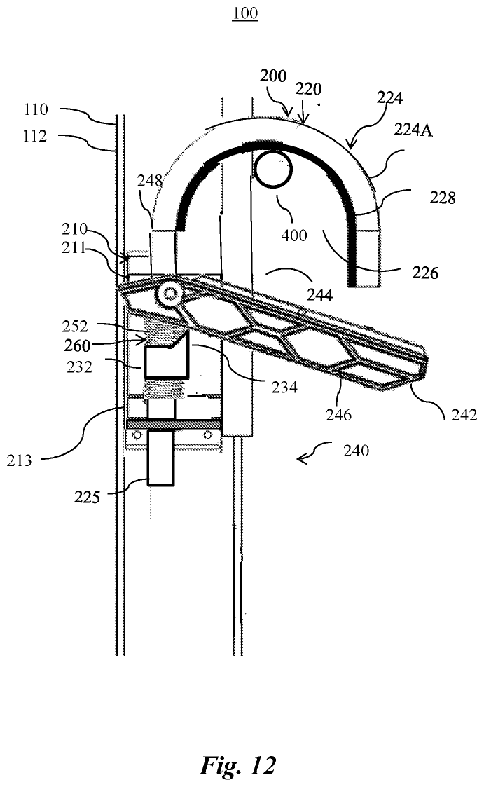

FIG. 12 shows the first safety apparatus 200 in an intermediate position during transition between the open position (shown in FIG. 10) and the closed position (shown in FIG. 13). The cable trap body 246 is shown as defining the retention member recess 244. Stated somewhat differently, the cable trap body 246 in the closed position, in cooperation with the upper side rail portion 112 of the first side rail 110, can form the retention member recess 244.

As shown in FIG. 12, as the compressing member 232 slides toward the first bracket member 211 during use of the ladder 100, the compressing member 232 compresses the spring 252 and engages the cable trap body 246 to rotate the cable trap body 246 toward the hook 224. As illustrated in in FIG. 12, the selected structure 400, such as a safety cable, exerts a force to move the hook 224 relative to the first and second bracket members 211, 213. The compressing member 232 compresses the spring 252 and engages the cable trap body 246 via the angled end portion 234.

FIG. 13 shows the first safety apparatus 200 in the closed position. As the compressing member 232 slides toward the first bracket member 211 further (in comparison with FIG. 12), the compressing member 232 can further compress the spring 252 and engage the cable trap body 246 to transition the cable trap body 246 to the closed position to capture the selected structure 400 within the hook mouth 226 between the non-skid surface material 228 and the retention member recess 244.

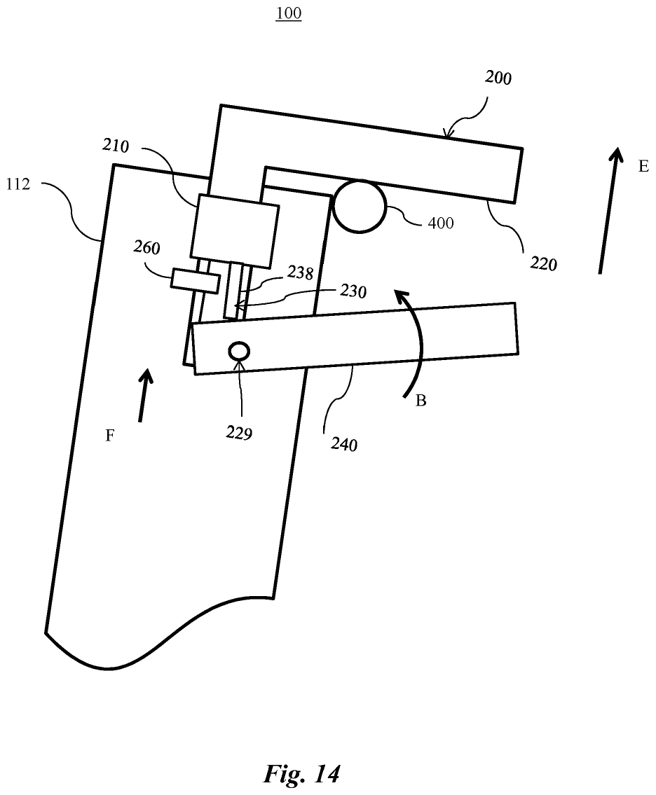

FIG. 14 shows the first safety apparatus 200 in an intermediate position during transition between the open position (shown in FIG. 2) and the closed position (shown in FIG. 4). The cooperating member 230 is shown as including a levering member 238 extending from the first mounting bracket 210.

The retention member 240 is shown as being rotatably coupled with the engagement member 220. When the weight is applied to the ladder 100, the engagement member 220 can slide relative to the first mounting bracket 210 such that the engagement member 220 can engage the first mounting bracket 210 to rotate the retention member 240 into the closed position.

The retention member 240 can be coupled to the engagement member 220 for making a translation movement synchronously with the engagement member 220. Thus, when the weight is applied to the ladder 100, the engagement member 220 can slide relative to the first mounting bracket 210 in the direction E. Accordingly, the retention member 240 can move in the direction F. Via movement in the direction F, the engagement member 220 can engage the first mounting bracket 210 to rotate the retention member 240 into the closed position. Stated somewhat differently, the levering member 238 can make the retention member 240 pivot such that the retention member 240 can rotate in the direction B to transition into the closed position.

FIG. 14 shows the retention member 240 as being rotatably coupled with the engagement member 220 via a support member 229 extending from the engagement member 220. The biasing system 260 can include at least one spring (not shown) being disposed between the support member 229 and the first mounting bracket 210. The biasing system 260 can bias the retention member 240 distally from the engagement member recess 222 of the engagement member 220. Stated somewhat differently, when the weight is not applied to the ladder 100, the biasing system 260 can provide a force to keep the retention member 240 from moving in the direction F and/or move relative to the mounting bracket 210. Thus, the biasing system 260 can prevent the levering member 238 from contacting the retention member 240 and/or pushing the retention member 240 to pivot into the closed position.

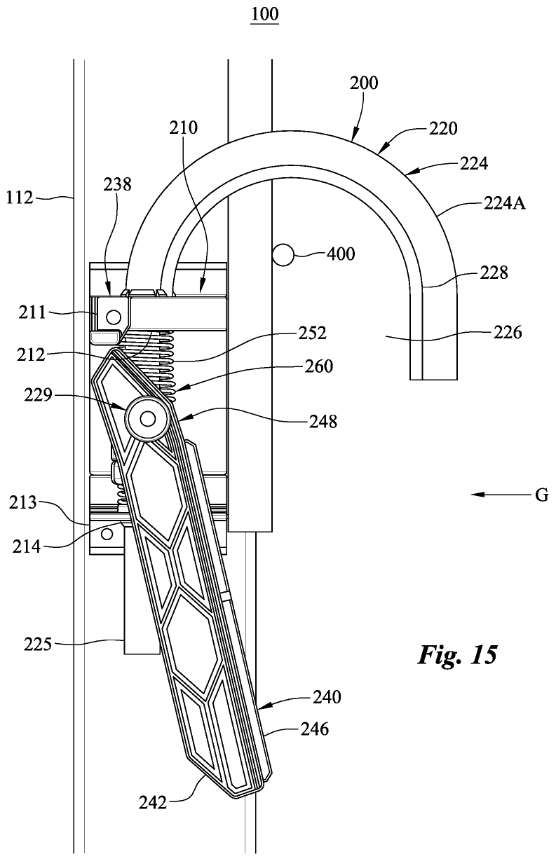

FIG. 15 shows a detail drawing of the first safety apparatus 200 in the open position. The first safety apparatus 200 is shown as including the first mounting bracket 210 with the first bracket member 211 defining the first bracket opening 212 and the second bracket member 213 defining the second bracket opening 214. The second bracket opening 214 is shown as being axially aligned with the first bracket opening 212.

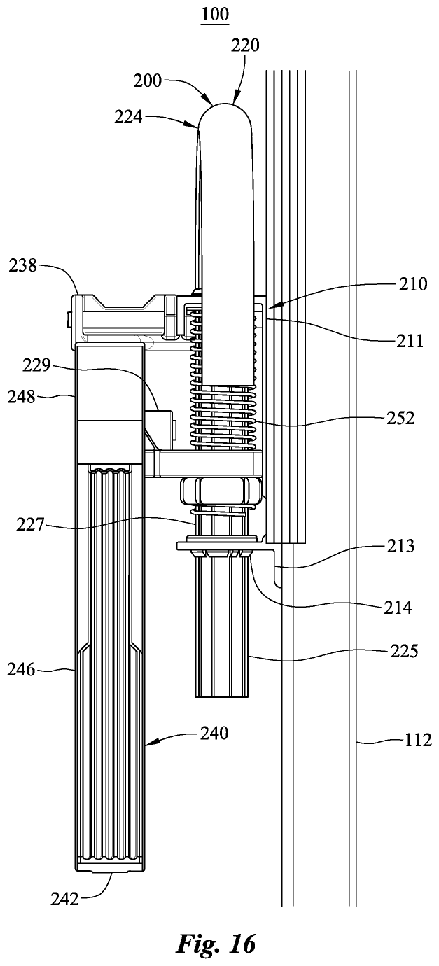

The first safety apparatus 200 is shown as including the engagement member 220 that includes the hook 224. The hook 224 can include a hook region 224A having an arcuate shape for defining the hook mouth 226. The engagement member 220 is shown as including a hook base region 225 having an external hook base region periphery 227 (shown in FIG. 16).

The engagement member 220 is shown as including the support member 229 extending from the hook base region periphery. The hook base region 225 can be slidably disposed within the first and second bracket openings 212, 214 such that the hook 224 extends from the first bracket member 211 and the support member 229 can be positioned between the first and second bracket members 211, 213.

The biasing system 260 shown in FIG. 15 includes a spring 252 disposed about the hook base region periphery between the first bracket member 211 and the support member 229. The spring 252 can bias the support member 229 adjacent to the second bracket member 213.

The first safety apparatus 200 is shown as including the retention member 240. The retention member 240 includes the cable trap body 246. The cable trap body 246 can have an elongated shape and have the end region 242. The end region 242 is shown as being distal from the hook 224. Stated somewhat differently, the end region 242 can extend distally from the hook 224 in the open position.

The cable trap body 246 can have an end region 248 located opposite to the end region 242. The end region 248 is shown as being proximal to the hook 224. Stated somewhat differently, the end region 248 can be proximal to the hook 224 in the open position.

FIG. 16 shows the first safety apparatus 200 of FIG. 15 that is viewed in the direction G (shown in FIG. 15). A hook base region periphery 227 is shown as extending from the hook base region 225 and located distally from the upper side rail portion 112. The end region 248 can be pivotally coupled with the first bracket member 211 and located distally from the upper side rail portion 112.

The support member 229 is shown as extending from the hook base region periphery 227 and coupled to the cable trap body 246. The levering member 238 is shown as extending from the first mounting bracket 210 and distally from the upper side rail portion 112 such that the levering member 238 can be in contact with the cable trap body 246 during movement of the cable trap body 246 in the direction E (shown in FIG. 14).

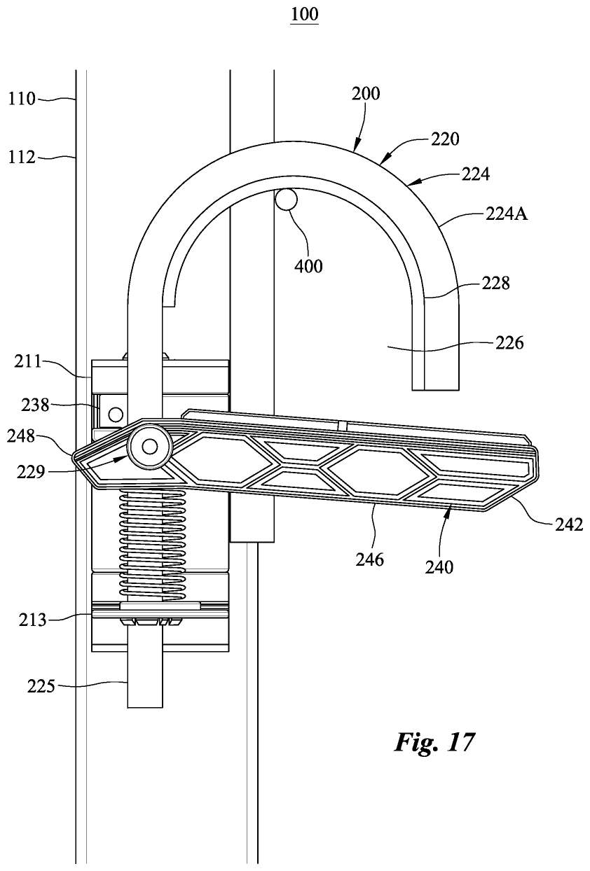

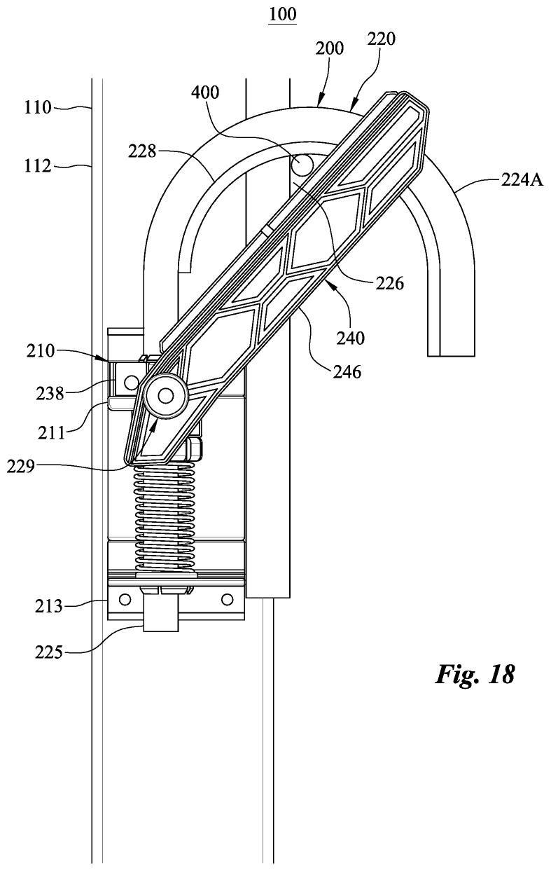

FIG. 17 shows the first safety apparatus 200 in an intermediate position during transition between the open position (shown in FIG. 15) and the closed position (shown in FIG. 18). The support member 229 slides toward the first bracket member 211 and enables the end region 248 to engage the first bracket member 211. Stated somewhat differently, the support member 229 slides toward the first bracket member 211 and enables the end region 248 to be pushed by the levering member 238 that extends from the first bracket member 211. Thus, the levering member 238 can rotate the cable trap body 246 from the open position to the closed position to capture the selected structure 400 within the hook mouth 226 between the hook 224 and the cable trap body 246.

As shown in FIG. 17, as the cable trap body 246 slides toward the first bracket member 211 during use, the support member 229 compresses the spring 252 (shown in FIG. 15) between the support member 229 and the first bracket member 211. The levering member 238 engages the cable trap body 246 to rotate the cable trap body 246 toward the hook 224. Stated somewhat differently, the selected structure 400, such as the safety cable, exerts a force to move the hook 224 relative to the first and second bracket members 211, 213. The support member 229 compresses the spring 252 and the first bracket member 211 engages the cable trap body 246 via the levering member 238.

FIG. 18 shows the first safety apparatus 200 in the closed position. As the support member 229 slides further toward the first bracket member 211 (in comparison with FIG. 17), the support member 229 can further compress the spring 252 (shown in FIG. 15) between the support member 229 and the first bracket member 211. The first bracket member 211 can engage the cable trap body 246 to transition the cable trap body 246 to the closed position to capture the selected structure 400 within the hook mouth 226. Stated somewhat differently, the first bracket member 211 can engage the cable trap body 246 via the levering member 238 to transition the cable trap body 246 to the closed position. The cable trap body 246 is shown as enclosing the hook mouth 226 in the closed position.

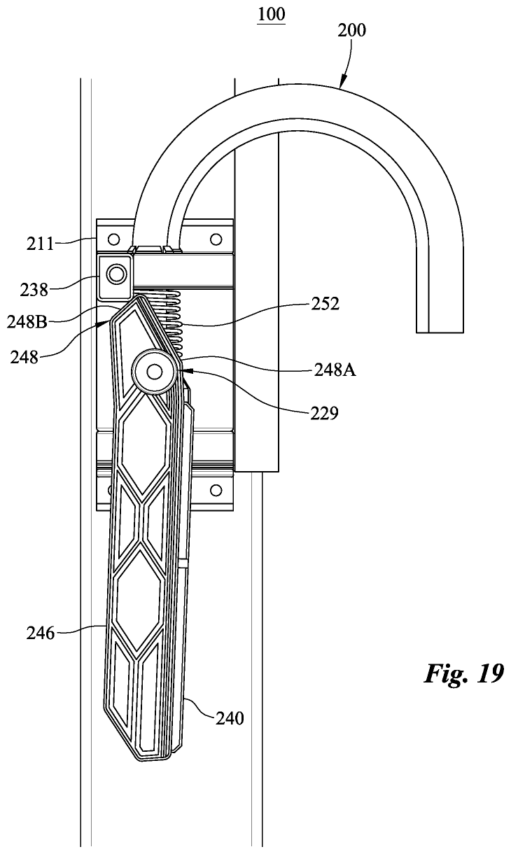

FIG. 19 shows the first safety apparatus 200 in a lock position. The end region 248 is shown as including first and second facets 248A, 248B abutting each other to form a ridge-shaped edge. The first and second facets 248A, 248B can be distal from and proximal to the levering member 238, respectively.

When the levering member 238 is in contact with the first facet 248A, the levering member 238 can enable transition of the cable trap body 246 from the open position (shown in FIG. 15) to the closed position (shown in FIG. 18). However, when the levering member 238 is in contact with the second facet 248B, the levering member 238 can inhibit pivoting of the cable trap body 246 from the open position to the closed position.

Stated somewhat differently, when the levering member 238 is in contact with the second facet 248B, the levering member 238 can stop the support member 229 from sliding toward the first bracket member 211 and/or block rotation of the cable trap body 246 even if the weight is applied to the ladder 100. Thus, the cable trap body 246 can be locked in the open position. As a result, when the ladder 100 is not in use, even if any weigh is applied to the ladder 100, the support member 229 does not compress the spring 252 and unnecessary compression of the spring 252 can be prevented. Advantageously, lifetime of the spring 252 and/or the first safety apparatus 200 can be extended and structure of the ladder 100 can be more sturdy and compact during handling and transportation.

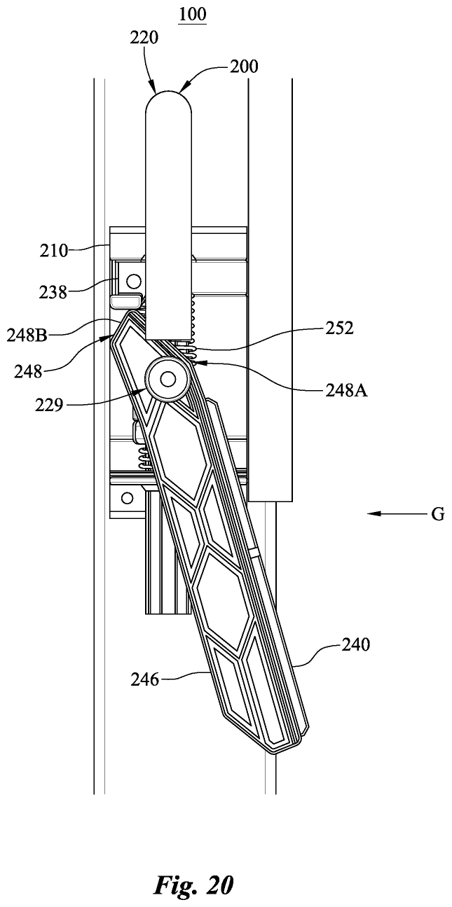

FIG. 20 shows the first safety apparatus 200 in a storage position. The first safety apparatus 200 can be rotatably coupled with the first mounting bracket 210. Stated somewhat differently, at least part of the first safety apparatus 200 can rotate about the first mounting bracket 210. As illustrated in FIG. 20, the engagement member 220 can rotate into a plane parallel with the rungs 140 (shown in FIG. 1). When the first safety apparatus 200 is not in use, the engagement member 220 can rotate about the first mounting bracket 210 from the open position (shown in FIG. 15) by a selected angle. The exemplary angle shown in FIG. 20 is 90 degrees.

Although FIG. 20 shows the first safety apparatus 200 as being in the storage position only, the second safety apparatus 300 (shown in FIG. 1) can be rotatably coupled with the second mounting bracket 310 and can rotate into the plane parallel with the rungs 140 when the second safety apparatus 300 is not in use.

Advantageously, the storage position can place the first safety apparatus 200 in a frame of the ladder 100 to minimize potential inadvertent scraping, puncturing or catching on other surfaces when transporting and storing the ladder 100. Similarly, the placement of the engagement member 220 can help to cover or protect barbs, teeth, or other engaging features that can be formed on the engagement member 220.

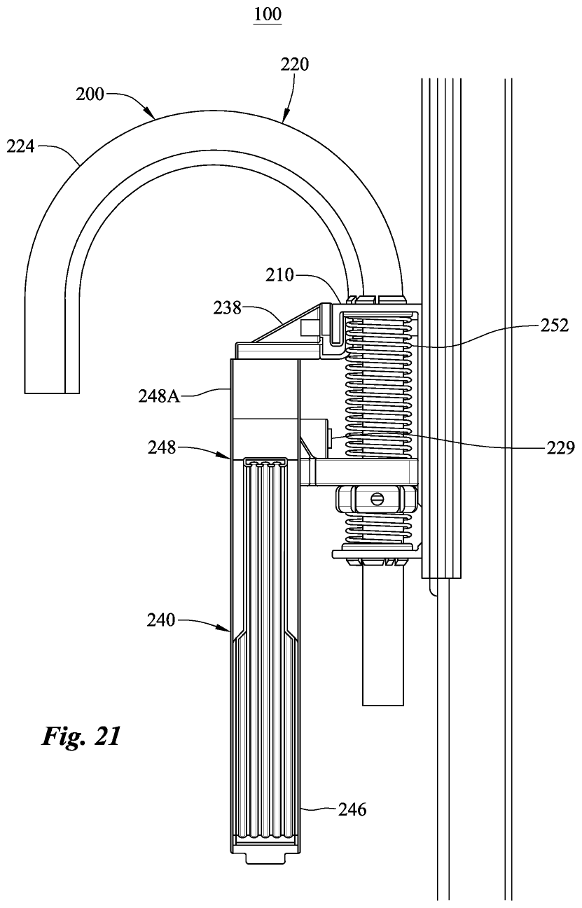

FIG. 21 shows the first safety apparatus 200 of FIG. 20 that is viewed in the direction G (shown in FIG. 20). FIG. 21 further illustrates the engagement member 220 as being in the plane parallel with the rungs 140 (shown in FIG. 1). The cable trap body 246 is shown as being in the open position without rotation about the first mounting bracket 210.

Although FIG. 21 shows the hook 224 as being rotatable about the first mounting bracket 210 only, additional and/or alternative parts fixedly coupled to the hook 224 can also rotate about the first mounting bracket 210, without limitation. In one example, the support member 229 and/or the cable trap body 246 can rotate about the first mounting bracket 210 and with the hook 224. In another example, the compressing member 232 (shown in FIG. 10) can rotate about the first mounting bracket 210.

Although shown and described above as engaging a safety cable or a horizontal support structure for purposes of illustration only, the safety apparatuses 200, 300 advantageously can be configured to provide support for the ladder 100 via a wide range of structures 400 (shown in FIG. 1) with selected horizontal, vertical and/or other components. In various embodiments, for example, the safety apparatuses 200, 300 can be configured to provide support for the ladder 100 via a non-horizontal support structure 400. Exemplary non-horizontal support structures 400 can include a utility pole, a tree, a pillar, a building or other support structure with a vertical component.

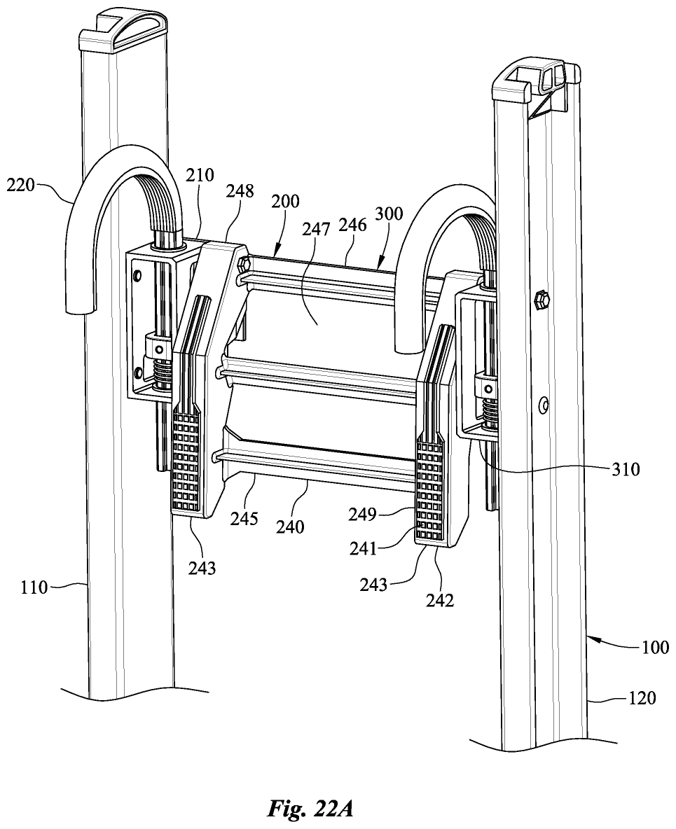

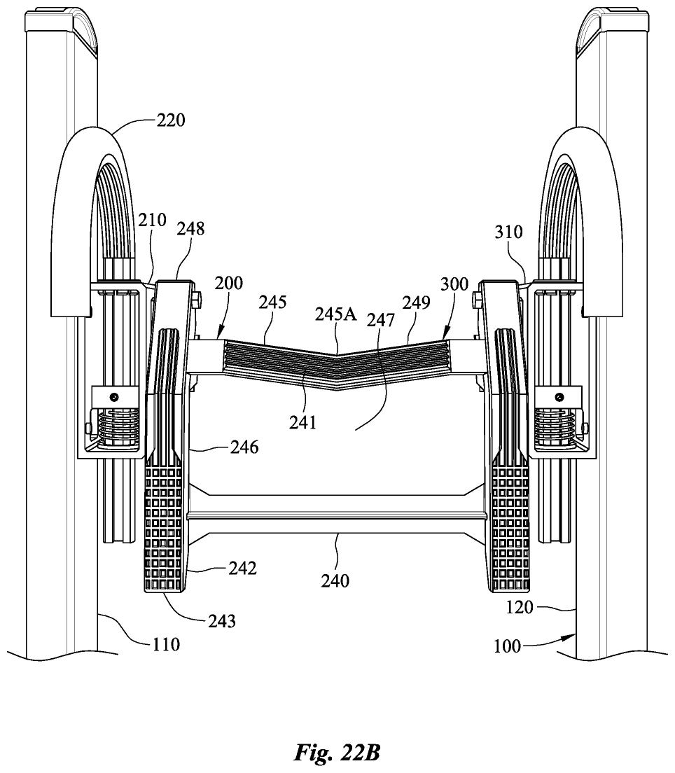

Turning to FIG. 22A, for example, the safety apparatus 200, 300 is shown as including a retention member 240 for engaging a vertical support structure (not shown). The retention member 240 can be coupled with the ladder 100 in any suitable manner, including via a fixed coupling and/or an adjustable coupling. As illustrated in FIG. 22A, for example, the retention member 240 is shown as being disposed between the first and second side rails 110, 120 of the ladder 100. The retention member 240 thus can be rotatably coupled with the first and second side rails 110, 120 via one or more respective mounting brackets 210, 310, which are shown and described in more detail herein, for example, with reference to FIGS. 1, 2 and 20.

The retention member 240 can comprise a retention member body 246. The retention member body 246 can have any predetermined shape and provide an engagement region 241 for engaging the vertical support structure. Although the engagement region 241 can comprise a planar surface for engaging vertical support structures with flat support surfaces such as, for example, a wall of a building, the body 246 of the retention member 240 advantageously can define a central channel 247 for receiving narrow vertical support structures, such as a utility pole.

As shown in FIG. 22A, the retention member 240 can include opposite side members 243. The side members 243 of the retention member 240 can be disposed adjacent to, and coupled with, the first and second side rails 110, 120, respectively. In other words, the retention member 240 can at least partially span a distance between the first and second side rails 110, 120. In one embodiment, the side members 243 can be at least partially integrated to form a single solid body 246. Additionally and/or alternatively, the side members 243 of the retention member body 246 can be coupled via one or more cross-members 245 as illustrated in FIG. 22A. The cross-members 245 can be disposed at any predetermined angle relative to the side members 243. Exemplary predetermined angles can include an angle of fifteen degrees, thirty degrees, forty-five degrees, sixty degrees, ninety degrees or any angle therebetween. As desired, the predetermined angle can comprise an angle within a selected range of angles, such as between five degrees and ninety degrees, including any angle sub-ranges, such as a five degree sub-range (i.e., between sixty-five degrees and seventy degrees) and/or a ten degree sub-range (i.e., between sixty degrees and seventy degrees), within the selected range of angles, without limitation.

The engagement region 241 thereby can be defined by the side members 243 and/or the cross-members 245. Although the side members 243 and the cross-members 245 can comprise coplanar body members, the cross-members 245 advantageously can be disposed in a cross-member plane that is different from a side member plane of the side members 243. By recessing the cross-members 245 within the body 246, for example, the side members 243 and the cross-members 245 can define the central channel 247. The central channel 247 advantageously can help to center the vertical support structure within the retention member 240 to help ensure that the ladder 100 is safely supported by the vertical support structure.

To help facilitate an engagement with the vertical support structure, a non-skid surface material 249 can be disposed on or otherwise provided on the engagement region 241. Stated somewhat differently, the non-skid surface material 249 can be disposed on or otherwise provided on one or more selected surface of the side members 243 and/or the cross-members 245. The non-skid surface material 249 can be provided, for example, in the manner set forth above with reference to the non-skid surface material 228 shown in FIG. 6.

An alternative embodiment of the retention member 240 is illustrated in FIG. 22B. Turning to FIG. 22B, the retention member 240 is shown as being provided in the manner set forth above with reference to FIG. 22A. The retention member 240 can include the engagement region 241 that is defined by the side members 243 and/or the cross-members 245. Here, one or more of the cross-members 245 can have a cross-member profile for further enhancing the engagement with vertical support structure (not shown).

As shown in FIG. 22B, a selected cross-member 245 can define a support recess 245A. The support recess 245A can receive and/or engage at least a portion of the vertical support structure. Being defined with any predetermined shape, size and/or dimension to accommodate the portion of the vertical support structure, the support recess 245A advantageously can help to center the vertical support structure within the retention member 240 to help further ensure that the ladder 100 is safely supported by the vertical support structure. The support recess 245A, for example, can be provided with a tapered shape, such as a “V” or “U” shape, for centering the vertical support structure within the retention member 240. In one embodiment, the support recess 245A can be provided with a suitable shape, size and/or dimension for receiving and/or engaging a range of different vertical support structures.

To help further facilitate the engagement with the vertical support structure, a non-skid surface material 249 optionally can be disposed on or otherwise provided on the selected cross-member 245. Stated somewhat differently, the non-skid surface material 249 can be disposed on or otherwise provided on the engagement region 241 that is at least partially defined by the selected cross-member 245. The non-skid surface material 249 can be provided, for example, in the manner set forth above with reference to the non-skid surface material 228 shown in FIG. 6.

Advantageously, the retention member 240 of FIGS. 22A-B optionally can cooperate with at least one engagement member 220. The retention member 240 can be rotatably coupled with the first and second side rails 110, 120 via one or more respective mounting brackets 210, 310 in the manner set forth in more detail above. An end region 242 of the retention member 240 thereby can be rotatable relative to the engagement member 220 such that the retention member 240 can extend distally from the engagement member 220 in an open position as shown in FIG. 22A. A selected structure 400 thereby can freely enter and exit from the engagement member recess 222 (collectively shown in FIG. 2).

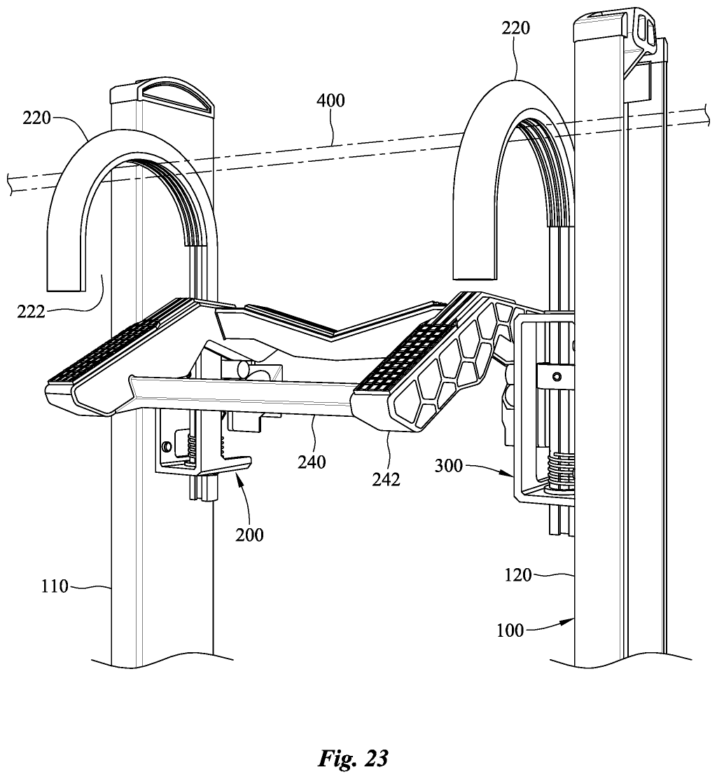

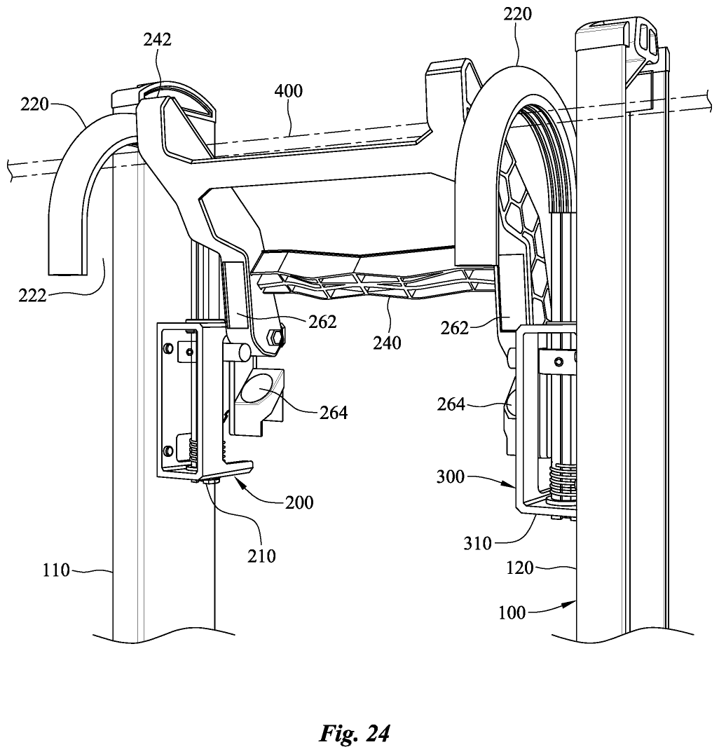

As the engagement member 220 further engages the selected structure 400, the end region 242 of the retention member 240 can rotate relative to the engagement member 220 toward a closed position as shown, for example, in FIG. 23. The end region 242 of the retention member 240 can continue to rotate relative to the engagement member 220 into the closed position as shown in FIG. 24. In the closed position, the selected structure 400 can be trapped in the engagement member recess 222. Thereby, the retention member 240 advantageously can provide support for the ladder 100 via a wide range of structures 400 with selected horizontal, vertical and/or other components.

In some embodiments, the retention member 240 can optionally be biased in the open position. Biasing the retention member 240 in the open position can offer several advantages. For example, the safety apparatus 200, 300 in the open position is configured to receive and/or engage structures 400 with selected horizontal, vertical and/or other components. The open position of the safety apparatus 200, 300 likewise can facilitate carrying, storing or other purposes of the ladder 100.

The safety apparatus 200, 300 can include a biasing system 260 for biasing the engagement member 220 and the retention member 240 into the open position in the manner discussed in more detail above, for example, with FIG. 2. Additionally and/or alternatively, the safety apparatus 200, 300 can include a magnetic system for biasing the engagement member 220 and the retention member 240 in the open position. As shown in FIG. 24, for example, at least one of the mounting brackets 210, 310 of the safety apparatus 200, 300 can include a magnet 264 for attracting the retention member 240. In one embodiment, the retention member 240 can be formed from a ferrous or other material that can be attracted by the magnet 264. Alternatively, the retention member 240 can include a magnetic region 262. The magnetic region 262 can be comprise a magnet and/or a ferrous or other material that can be attracted by the magnet 264. The magnetic region 262 can be formed on, adhered to, disposed within or otherwise coupled with the retention member 240. Preferably, the magnetic region 262 aligns with the magnet 264 when the engagement member 220 and the retention member 240 are in the open position.

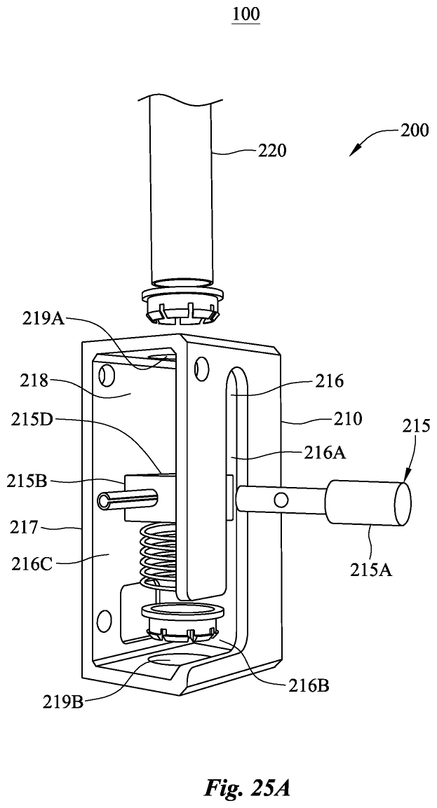

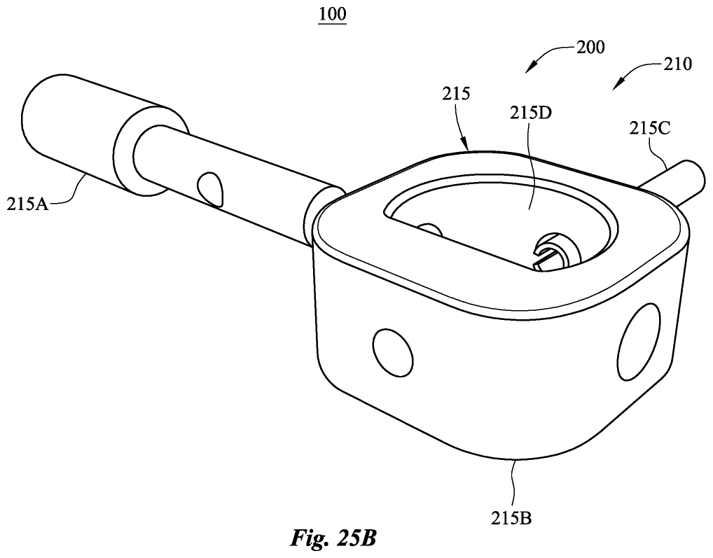

An alternative embodiment of the mounting bracket 210 is shown in FIGS. 25A-B. The engagement member 220 can be engaged by, and slidable relative to, the mounting bracket 210. The mounting bracket 210 thereby can provide adjustable support for the engagement member 220. Turning to FIG. 25A, the mounting bracket 210 can include a mounting bracket housing 217. The mounting bracket housing 217 can define an internal chamber 218 that can communicate with first and second housing openings 219A, 219B. The engagement member 220 can be at least partially received into, and extend externally from, the mounting bracket housing 217 via the first housing opening 219A. In other words, the engagement member 220 can be at least partially disposed within the internal chamber 218. The engagement member 220 can extend from the mounting bracket housing 217 via the second housing opening 219B. By slidably engaging the engagement member 220, the mounting bracket 210 can provide adjustable support for the engagement member 220 with one or more points of contact in the manner discussed above.

FIG. 25B shows that the mounting bracket 210 can include an extension member assembly 215 for engaging the retention member 240. The extension member assembly 215 includes a central support member 215B that defines an opening 215D. The opening 215D has a suitable size, shape and/or dimension for receiving a portion of the engagement member 220 that is positioned within the mounting bracket housing 217 when the mounting bracket 210 is assembled. In other words, the central support member 215B can be disposed about a periphery of the portion of the engagement member 220 within the mounting bracket housing 217. The central support member 215B can be fixedly coupled with the engagement member 220 in any conventional manner, such as a fastener 215C.

An extension member 215A can extend from the central support member 215B as shown in FIG. 25B. The extension member 215A preferably is fixedly coupled with the central support member 215B. Although shown in FIGS. 25A-B as comprising a pin element with a non-uniform diameter, the extension member 215A can be provided with any suitable size, shape and/or dimension. The extension member 215A can be figured to engage the retention member 240, such as the retention member 240 shown in FIGS. 22A-B, 23 and 24

Returning to FIG. 25A, the mounting bracket housing 217 can define a third housing opening 216. Like the first and second housing openings 219A, 219B, the third housing opening 216 can communicate with the internal chamber 218. The third housing opening 216 can include a first opening portion 216A that can be formed along a length of the mounting bracket housing 217 and sized to at least partially receive the extension member 215A. The engagement member 220 and the extension member assembly 215 can be disposed within the internal chamber 218 such that the extension member 215A extends at least partially through the third housing opening 216 as shown in FIG. 25A.

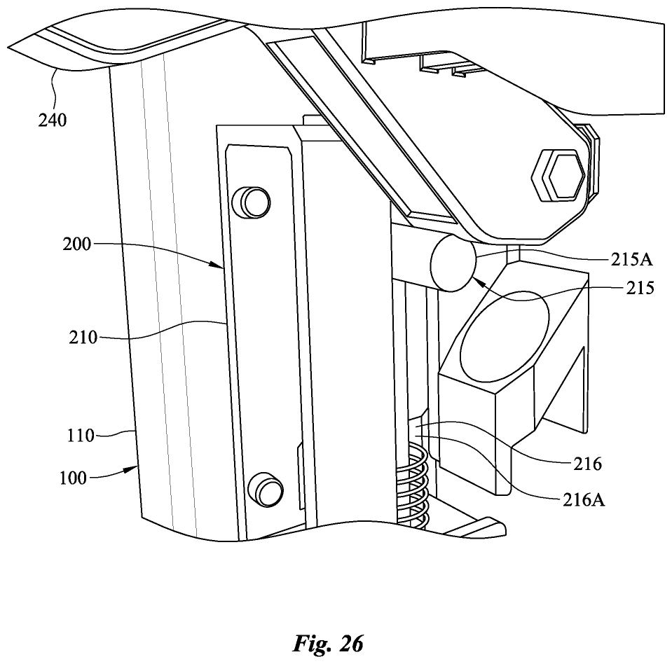

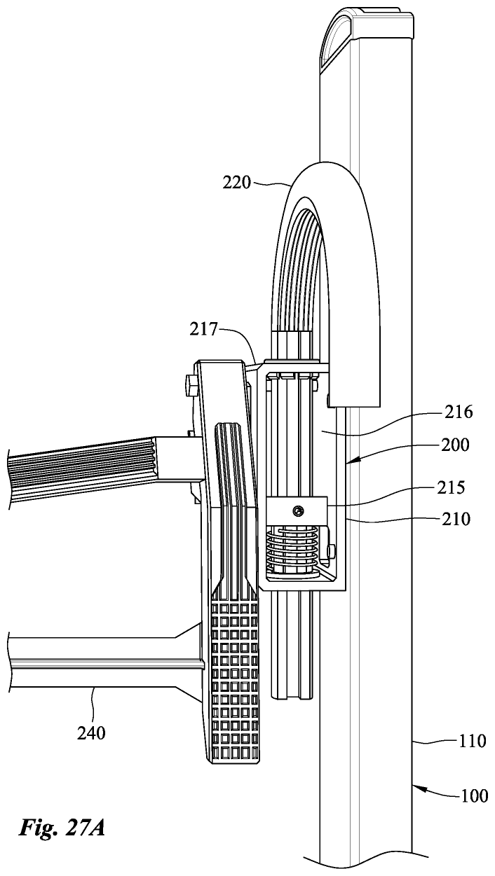

The extension member 215A can be coupled with the extension member assembly 215 at any time, including before or after the engagement member 220 and the extension member assembly 215 are disposed within the internal chamber 218. As the engagement member 220 moves relative to the mounting bracket housing 217, the extension member 215A can traverse the first opening portion 216A and engage the retention member 240 as illustrated in FIG. 26. By engaging the retention member 240, the extension member 215A advantageously can rotate the engagement member 220 from the open position to the closed position (and back to the open position) as desired as the engagement member 220 moves relative to the mounting bracket housing 217.

Additionally and/or alternatively, the third housing opening 216 can include optional second and third opening portions 216B, 216C. The second and third opening portions 216B, 216C can communicate with the internal chamber 218 and the first opening portion 216A of the mounting bracket housing 217. The second opening portion 216B can be can along a width of the mounting bracket housing 217 adjacent to the second housing opening 219B. In other words, the second opening portion 216B can be distal from the first housing opening 219A from which the engagement member 220 extends.

The third opening portion 216C can be formed along a length of the mounting bracket housing 217 and distally from the first opening portion 216A. In one embodiment as illustrated in FIG. 25A, the first opening portion 216A can be formed in a first selected sidewall of the mounting bracket housing 217; whereas, the third opening portion 216C can be formed in a second selected sidewall of the mounting bracket housing 217 that is different from the first selected sidewall of the mounting bracket housing 217. Preferably, the first selected sidewall of the mounting bracket housing 217 is normal to the second selected sidewall of the mounting bracket housing 217. The second and third opening portions 216B, 216C each can be sized to at least partially receive the extension member 215A. The first and third opening portions 216A, 216C preferably communicate via the second opening portion 216B, forming a path by which the extension member 215A can traverse from the first opening portion 216A to the third opening portion 216C and back again.

In operation, the engagement member 220 of the safety apparatus 200, 300 can rotate relative to the mounting bracket 210 in the manner discussed in more detail above with reference to FIGS. 19-21. The engagement member 220 thereby can rotate from an open position to a closed position. In the open position, the engagement member 220 is disposed in a plane that is normal to the rungs 140 (shown in FIG. 1) of the ladder 100. In other words, the engagement member 220 in the open position is configured to engage the selected structure 400 (shown in FIG. 1). The engagement member 220 in the closed position is disposed in a plane that is parallel to the rungs 140 of the ladder 100. The engagement member 220 in the closed position thus can facilitate carrying, storing or other purposes of the ladder 100. The mounting bracket 210 of FIGS. 25A-B and 26 can help facilitate the rotation of the engagement member 220 before and/or after use.

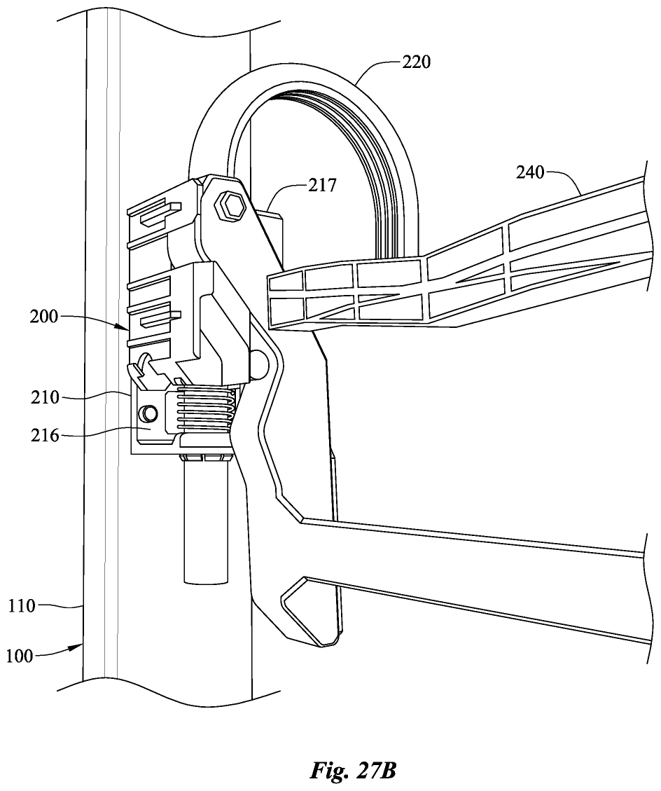

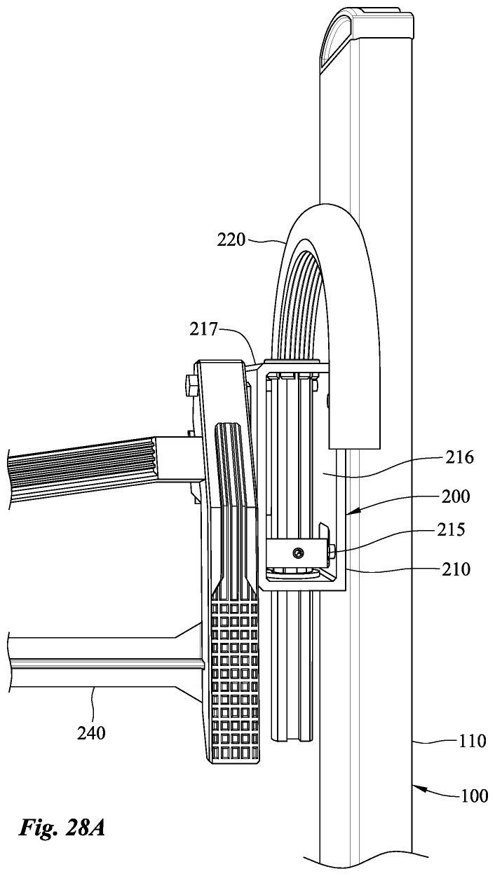

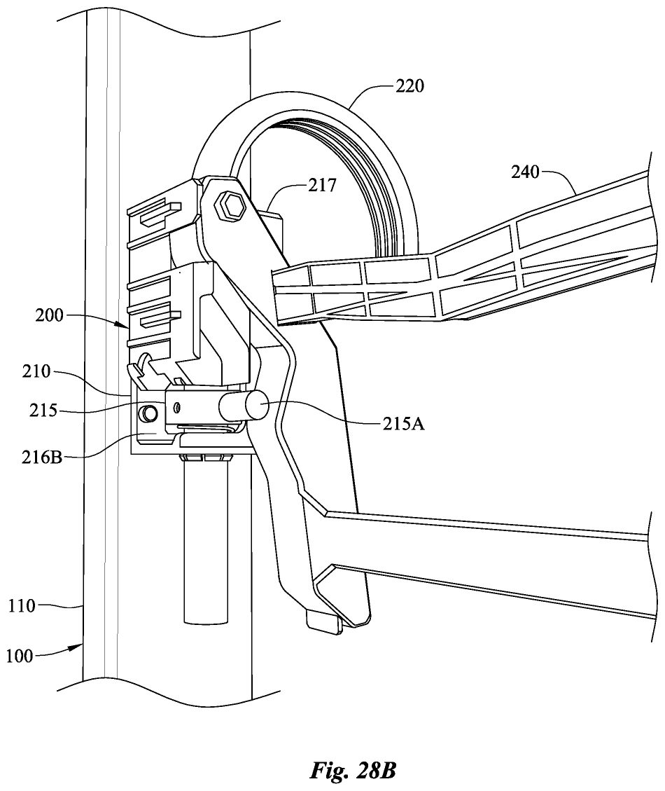

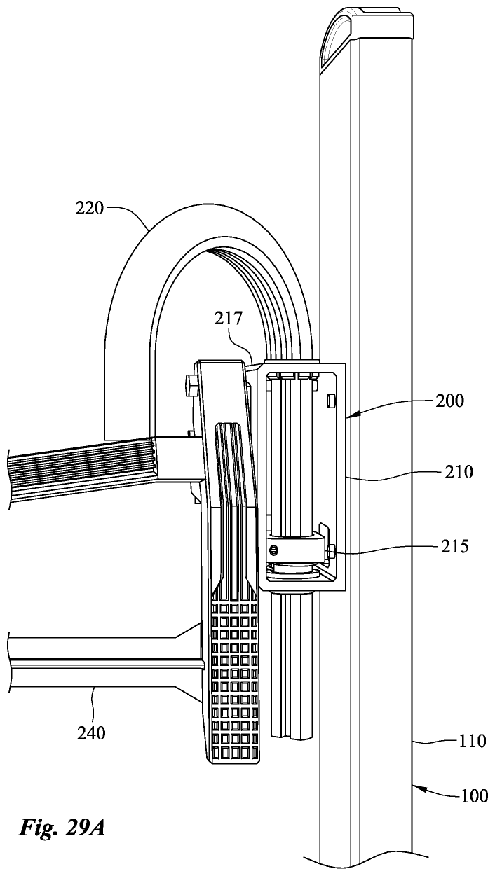

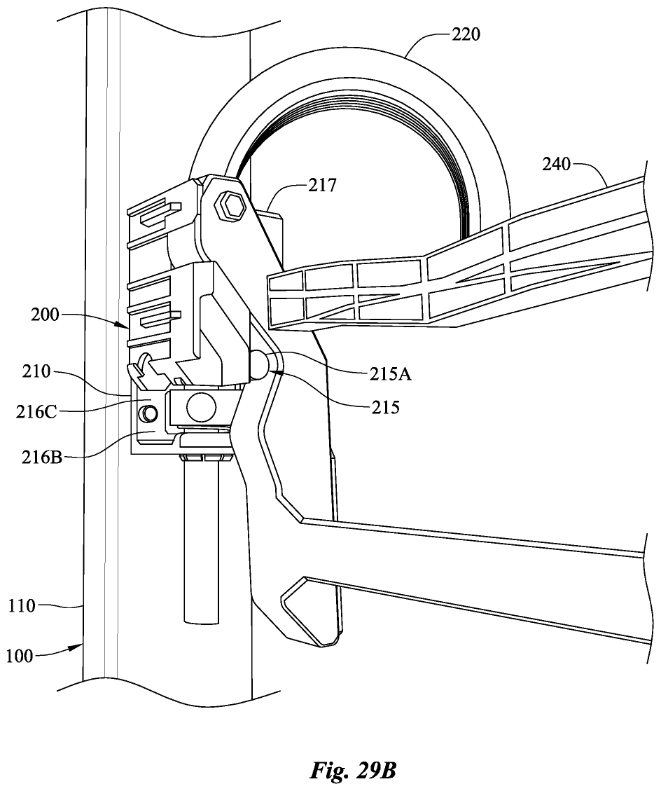

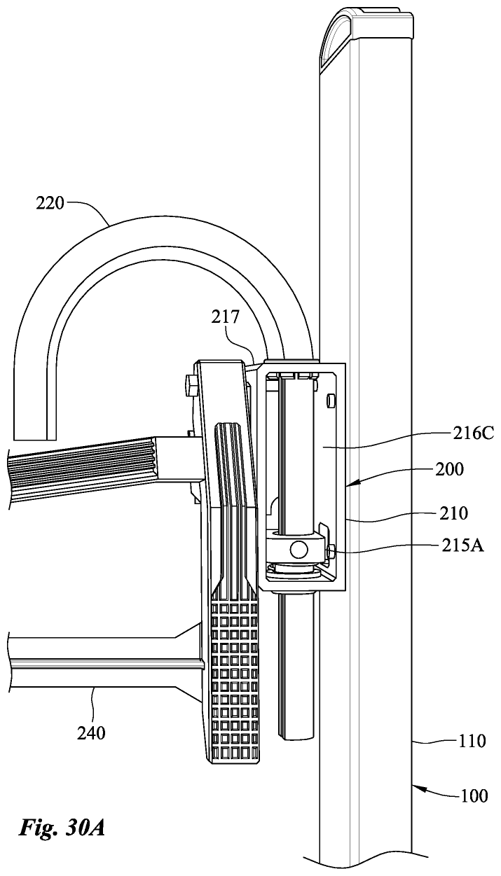

FIGS. 27A-B show the safety apparatus 200, 300 with the mounting bracket 210 of FIGS. 25A-B and 26 as being in a ready state for engaging a support structure 400 (shown in FIG. 1). Turning to FIGS. 28A-B, the engagement member 220 is shown as being pressed into a retracted position. The pressure (or force) applied to the engagement member 220 can be manually applied by a user of the ladder 100 and can enable the extension member 215A to traverse the first opening portion 216A toward the second opening portion 216B as shown in FIG. 28B. The extension member 215A preferably is aligned with the second opening portion 216B. Once the extension member 215A is sufficiently aligned with the second opening portion 216B, the engagement member 220 can be rotated such that the extension member assembly 215 can rotate within the mounting bracket housing 217 as illustrated in FIGS. 29A-B. The extension member 215A thereby can travel from the first opening portion 216A and into the second opening portion 216B.

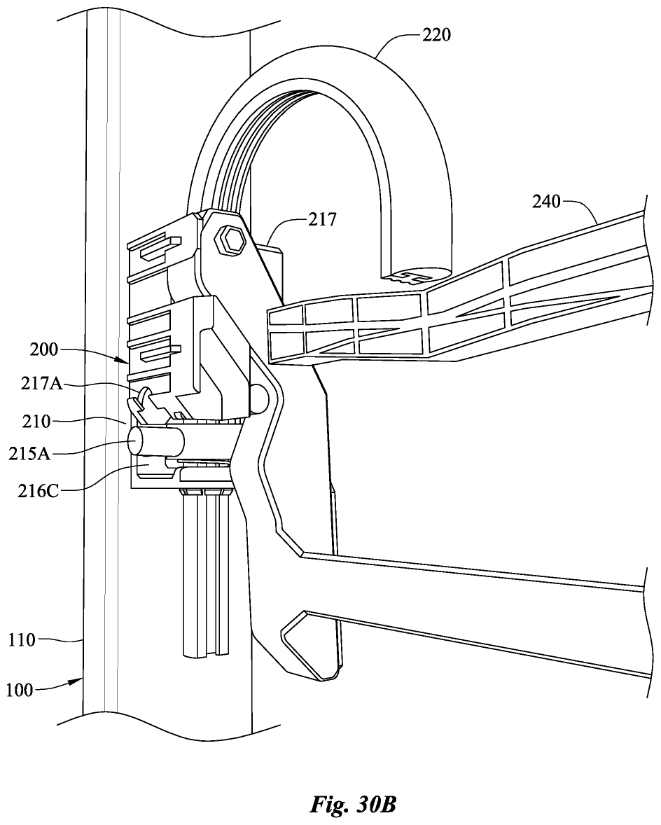

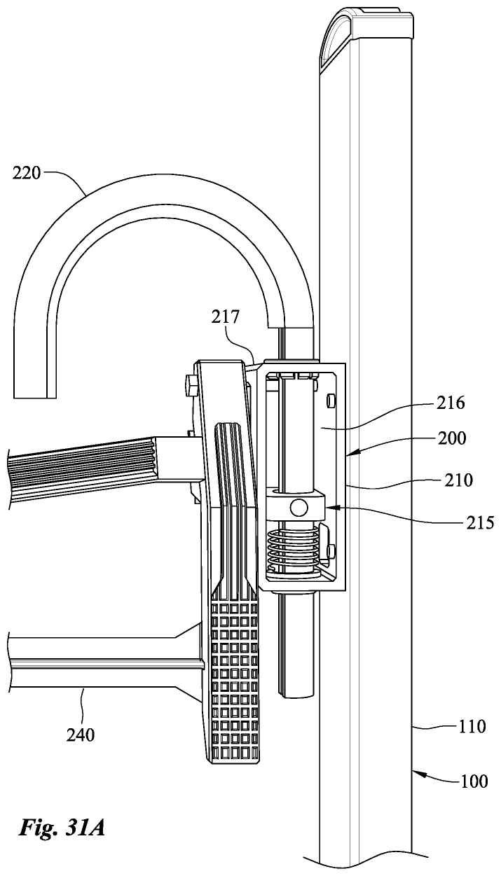

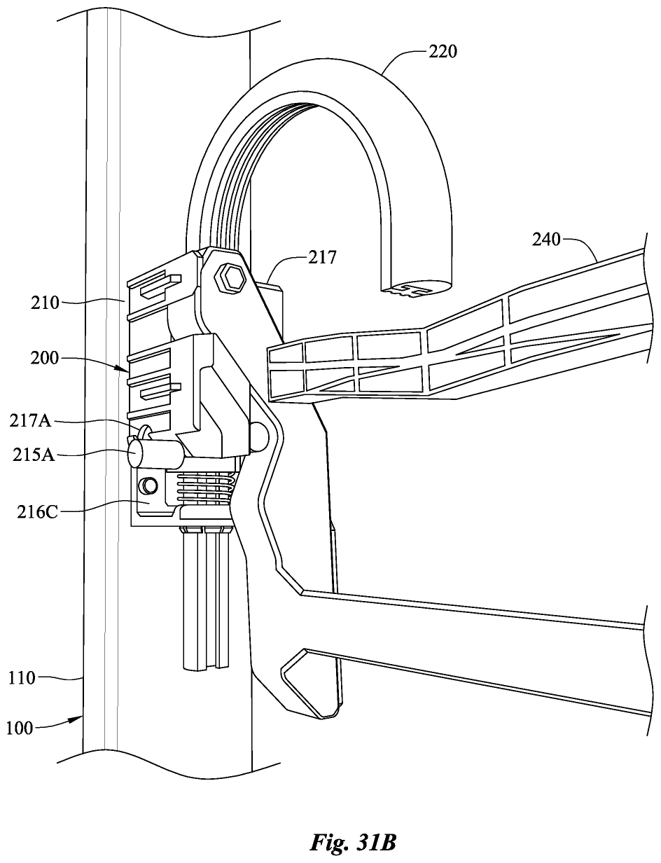

The rotation of the engagement member 220 can continue until the engagement member 220 achieves a stowed position, wherein the engagement member 220 is parallel with the rungs 140 (shown in FIG. 1) of the ladder 100. The continued rotation of the engagement member 220 can enable the extension member 215A to traverse the second opening portion 216B and approach the third opening portion 216C as shown in FIGS. 30A-B. Upon reaching the third opening portion 216C, the engagement member 220 can be released such that the extension member 215A can traverse the third opening portion 216C in the manner illustrated in FIGS. 31A-B. In one embodiment, the biasing system 260 (shown in FIG. 2) can bias the engagement member 220 into the third opening portion 216C. The engagement member 220 thereby can be maintained in the stowed position until the ladder 100 is again ready for use.

Advantageously, the mounting bracket housing 217 can include an optional recess 217A as shown in FIG. 31B. The recess 217A can receive the extension member 215A while the engagement member 220 is in the stowed position. By disposing the extension member 215A in the recess 217A, the ladder 100 can maintain the stowed position while being carried, stored or used for other purposes.

Although selected embodiments have been shown and described herein with reference to the first safety apparatus 200, it will be appreciated that the selected embodiments apply equally to the second safety apparatus 300. It also should be noted that, for purposes of the present disclosure, the phrase “at least one of A, B and C” is intended to include a construction as meaning “at least one of A and/or at least one of B and/or at least one of C.”

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A ladder safety apparatus, comprising:
a first engagement member for coupling with a first rail of a ladder and defining a first engagement member recess;
a second engagement member for coupling with a second rail of the ladder and defining a second engagement member recess; and
a third engagement member for coupling with the first and second rails and being rotatable between a first position for engaging a first support structure and a second position for at least partially enclosing a second support structure within the first and second engagement member recesses.

2. The ladder safety apparatus of claim 1, wherein at least one of said first and second engagement members comprises a cable hook with an arcuate hook region for receiving the second support structure, said third engagement member capturing the second support structure within the arcuate hook region in the second position.

3. The ladder safety apparatus of claim 1, wherein the first support structure comprises a non-horizontal support structure, wherein the second support structure comprises a horizontal support structure, or both.

4. The ladder safety apparatus of claim 3, wherein the non-horizontal support structure includes a utility pole, a tree, a pillar or a building, or wherein the horizontal support structure includes a wire, a cord, a cable, an overhead cable, a gutter, a utility line, a telephone cable, a cable television cable, a power line or a safety cable.

5. The ladder safety apparatus of claim 1, wherein said third engagement member comprises a body defining a central channel for engaging the first support structure in the first position and having opposite first and second side members for cooperating with the first and second engagement member recesses, respectively, in the second position.

6. The ladder safety apparatus of claim 5, wherein the first side member at least partially encloses the second support structure within the first engagement member recess in the second position, and wherein the second side member at least partially encloses the second support structure within the second engagement member recess in the second position.

7. The ladder safety apparatus of claim 5, wherein the first engagement member recess, the second engagement member recess, at least one of opposite side members, the central channel or a combination thereof are lined with a non-skid material.

8. The ladder safety apparatus of claim 1, wherein said first and second engagement members are movably coupled with the respective first and second rails and engage said third engagement member to rotate said third engagement member from the first position to the second position.

9. The ladder safety apparatus of claim 8, wherein said first engagement member translates relative to a longitudinal axis of the first rail, and wherein said second engagement member translates relative to a longitudinal axis of the second rail.

10. The ladder safety apparatus of claim 8, wherein said first and second engagement members rotate said third engagement member from the first position to the second position while translating toward respective end regions of the first and second rails.

11. The ladder safety apparatus of claim 1, further comprising a first mounting bracket for coupling with the first rail and a second mounting bracket for coupling with the second rail, wherein said first and third engagement members couple with the first rail via said first mounting bracket, and wherein said second and third engagement members couple with the second rail via said second mounting bracket.

12. The ladder safety apparatus of claim 11, wherein said first mounting bracket enables said first engagement member to translate relative to a longitudinal axis of the first rail, wherein said second mounting bracket enables said second engagement member to translate relative to a longitudinal axis of the second rail, and wherein said first and second mounting brackets enable said third engagement member to rotate between the first and second positions.

13. The ladder safety apparatus of claim 12, wherein said first engagement member includes a first engagement member base and a first engagement member portion defining the first engagement member recess, and wherein said first mounting bracket includes a first mounting bracket housing defining axially-aligned first and second mounting bracket housing openings for slidably receiving said first engagement member base, said first engagement member portion extending from said first mounting bracket housing via the first mounting bracket housing opening of said first mounting bracket housing, and
wherein said second engagement member includes a second engagement member base and a second first engagement member portion defining the second engagement member recess, and wherein said second mounting bracket includes a second mounting bracket housing defining axially-aligned first and second mounting bracket housing openings for slidably receiving said second engagement member base, said second engagement member portion extending from said second mounting bracket housing via the second mounting bracket housing opening of said second mounting bracket housing.

14. The ladder safety apparatus of claim 13, wherein said first engagement member base extends from said first mounting bracket housing via the second mounting bracket housing opening of said first mounting bracket housing, and further comprising a first extension member extending from said first engagement member base, wherein said first mounting bracket housing defines a first elongated channel having a first end region adjacent to the first mounting bracket housing opening of said first mounting bracket housing and a second end region adjacent to the second mounting bracket housing opening of said first mounting bracket housing, said first extension member extending from said first mounting bracket housing via the first elongated channel of said first mounting bracket housing and engaging said third engagement member, and
wherein said second engagement member base extends from said second mounting bracket housing via the second mounting bracket housing opening of said second mounting bracket housing, and further comprising a second extension member extending from said second engagement member base, wherein said second mounting bracket housing defines a first elongated channel having a first end region adjacent to the second mounting bracket housing opening of said second mounting bracket housing and a second end region adjacent to the second mounting bracket housing opening of said second mounting bracket housing, said second extension member extending from said second mounting bracket housing via the first elongated channel of said second mounting bracket housing and engaging said third engagement member.

15. The ladder safety apparatus of claim 14, wherein said first extension member is disposed adjacent to the first end region of the first elongated channel of said first mounting bracket housing when said third engagement member is in the first position, wherein said first extension member is disposed adjacent to the second end region of the first elongated channel of said first mounting bracket housing when said third engagement member is in the second position, wherein said first extension member translates from the first end region of the first elongated channel of said first mounting bracket housing to the second end region of the first elongated channel of said first mounting bracket housing to rotate said third engagement member from the first position to the second position or a combination thereof, and
wherein said second extension member is disposed adjacent to the first end region of the first elongated channel of said second mounting bracket housing when said third engagement member is in the first position, wherein said second extension member is disposed adjacent to the second end region of the first elongated channel of said second mounting bracket housing when said third engagement member is in the second position, wherein said second extension member translates from the first end region of the first elongated channel to the second end region of the first elongated channel to rotate said third engagement member from the first position to the second position or a combination thereof.

16. The ladder safety apparatus of claim 14, wherein said first mounting bracket housing enables said first engagement member to rotate into a first stowed position being parallel to one or more cross-members coupling the first and second rails when not in use, and wherein said second mounting bracket housing enables said second engagement member to rotate into a second stowed position being parallel to the one or more cross-members when not in use.

17. The ladder safety apparatus of claim 16, wherein said first mounting bracket housing defines a second elongated channel being normal to the first elongated channel of said first mounting bracket housing and having a first end region being in communication with the first end region of the first elongated channel and a second end region, said first extension member extending from said first mounting bracket housing via the second end region of the second elongated channel in the first stowed position, and
wherein said second mounting bracket housing defines a second elongated channel being normal to the first elongated channel of said second mounting bracket housing and having a first end region being in communication with the first end region of the first elongated channel and a second end region, said second extension member extending from said second mounting bracket housing via the second end region of the second elongated channel of said second mounting bracket housing in the second stowed position.

18. The ladder safety apparatus of claim 17, wherein said first extension member traverses the second elongated channel when transitioning between use and the first stowed position, and wherein said second extension member traverses the second elongated channel of said second mounting bracket housing when transitioning between use and the second stowed position.

19. The ladder safety apparatus of claim 17, further comprising first and second biasing systems, wherein the second end region of the second elongated channel includes a recess for receiving said first extension member and said first biasing system maintains said first extension member in the recess in the first stowed position, and wherein the second end region of the second elongated channel of said second mounting bracket housing includes a recess for receiving said second extension member and said second biasing system maintains said second extension member in the recess in the second stowed position.

20. The ladder safety apparatus of claim 16, further comprising a magnetic retention system for maintaining said third engagement member in a third stowed being parallel to the one or more cross-members.
